(19) United States
(12) Patent Application Publication
(10) Pub. No.: US 2009/0125454 A1
(43) Pub. Date: May 14, 2009

(54) SOFTWARE FOR AUTOMATICALLY PROVIDING QUOTES

(76) Inventor: Daniel Wartel, Southfield, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/914,162

(22) PCT Filed: May 11, 2005
(86) PCT No.: PCT/US05/16447

§ 371 Date: Aug. 26, 2008

Related U.S. Application Data
(60) Provisional application No. 60/570,050, filed on May 11, 2004.
(60) Provisional application No. 60/588,199, filed on Jul. 15, 2004.

(51) Int. Cl. G06F 17/00

(52) U.S. Cl. 705/400

(57) ABSTRACT

A method for automatically generating a price quote by inputting information relevant to the price quote into software and automatically generating the quote using the software. Automatic quoting means for automatically creating quotes.

### BACKGROUND OF THE INVENTION

1. Technical Field

Generally, the present invention relates to software. More specifically, the present invention relates to software for automatically providing quotes for manufacturing or servicing suppliers.

2. Background Art

Many manufacturers are required to provide cost estimates with regard to the costs for producing an item. Many individuals who routinely provide quotes have haphazard methods for providing quotes to their customers. The primary problem with such methods is that there is no reproducibility. The lack of reproducibility is a direct result of the non-standardized methods used in creating the quote.

An additional problem with regard to the current methods is that a company cannot determine, after a project has been completed, what portions of the quote is accurate and what is inaccurate. In other words, if upon completion of a project a company has lost money, there is no methodology in place that enables the company to determine what portion of the quote was incorrect. Alternatively, if a company has made a large profit on a project, there is no mechanism in place to analyze what portion of the quote is correct.

Further, the quoting methods currently used are primarily accomplished by putting pen to paper or by a group of individuals discussing what each person estimates the quote should be. Again, there is little reproducibility with such methods and it is nearly impossible to determine what aspects of a quote are accurate or inaccurate.

It would be beneficial if software were developed that could automate the quoting process. While there are a number of different types of software available for other uses, none provide an accurate means for quoting the costs of production of items. Additionally, none provide the ability to analyze a quote after the project has been completed.

Based upon the inaccuracies with the currently available quote methods, there is a basic need for a method, system, or software that can automatically calculate a quote. It would also be useful to develop software that can reliably provide quotes for customers. It would also be useful to develop software that automatically provides such quotes to the customers.

### SUMMARY OF THE INVENTION

According to the present invention, there is provided a method for automatically generating a price quote by inputting information relevant to the price quote into software and automatically generating the quote using the software. Automatic quoting means for automatically creating quotes is also provided.

### BRIEF DESCRIPTION OF THE DRAWINGS

Other advantages of the present invention are readily appreciated as the same becomes better understood by reference to the following detailed description when considered in connection with the accompanying drawings wherein:

FIG. 1 is a screen shot from the software interface;

FIG. 2 is a screen shot from the software interface;

FIG. 3 is a screen shot from the software interface;

FIG. 4 is a screen shot from the software interface;

FIG. 5 is a screen shot from the software interface;

FIG. 6 is a screen shot from the software interface;

FIG. 7 is a screen shot from the software interface;

FIG. 8 is a screen shot from the software interface;

FIG. 9 is a screen shot from the software interface;

FIG. 10 is a screen shot from the software interface;

FIG. 11 is a screen shot from the software interface;

FIG. 12 is a screen shot from the software interface;

FIG. 13 is a screen shot from the software interface;

FIG. 14 is a screen shot from the software interface;

FIG. 15 is a screen shot from the software interface;

FIG. 16 is a screen shot from the software interface;

FIG. 17 is a screen shot from the software interface;

FIG. 18 is a screen shot from the software interface;

FIG. 19 is a screen shot from the software interface;

FIG. 20 is a screen shot from the software interface;

FIG. 21 is a screen shot from the software interface;

FIG. 22 is a screen shot from the software interface;

FIG. 23 is a screen shot from the software interface;

FIG. 24 is a screen shot from the software interface;

FIG. 25 is a screen shot from the software interface;

FIG. 26 is a screen shot from the software interface;

FIG. 27 is a screen shot from the software interface;

FIG. 28 is a screen shot from the software interface;

FIG. 29 is a screen shot from the software interface;

FIG. 30 is a screen shot from the software interface;

FIG. 31 is a screen shot from the software interface;

FIG. 32 is a screen shot from the software interface;

FIG. 33 is a screen shot from the software interface;

FIG. 34 is a screen shot from the software interface;

FIGS. 35A and B are screen shots from the software interface;

FIGS. 36 A-K are flow charts for the method of the present invention; FIG. 36A depicts creating quote workflow; FIG. 36B depicts editing quote workflow; FIG. 36C depicts tool status workflow; FIG. 36D depicts quote status workflow; FIG. 36E depicts converting quotes to job workflow; FIG. 36F depicts tools workflow; FIGS. 36G and 36H depict requote workflow; FIG. 36I depicts report workflow; and FIG. 36J depicts administrative functions workflow; and

FIGS. 37A-E is the source code for the software of the present invention including the quote system (FIG. 37A), density metric calculations (FIG. 37B), and labor rate calculator (FIG. 37C).

### DESCRIPTION OF THE INVENTION

The present invention provides a method for automatically providing quotes. Preferably, the method is performed by software that automatically provides quotes for manufacturing and servicing suppliers. More specifically, the present invention provides software that can automatically create, track, and analyze quotes.

In addition to the quoting method, the present invention provides a method and tool for viewing historical results to gain insight in bidding penetration for management. The tool sorts by different categories including, but not limited to, customer, salesman, and end user to identify where the best future prospects are as well as what areas to avoid in the future. This gives the information to management by a simple selection of a date range and a selection of the sort method to direct the company to greater success.

The term “quotes” is intended to include, but is not limited to, an estimate or bid regarding the anticipated costs associated with a project or the purchase of an item or items. For example, the quote can pertain to the costs associated with obtaining raw materials. Additionally, the quote can pertain to the costs associated with performing a project, such as an injection molding project, a metal stamping project, or other quotable manufacturing or servicing project.

The term “software” as used herein is intended to include, but is not limited to, a computer run device for performing the function defined herein. The software included herewith is written in a specific language; however, any computer language can be used. For example, the software can be written in C+, C++, C+++, SQL, Microsoft Excel, Java, HTML, and other languages known to those of skill in the art that are able to function in the manner described herein. The software can be installed on individual computers, on a network of computers, or available via large scale networking system such as an Intranet, the Internet, or other similar communication device.

The software of the present invention is able to provide quotes automatically. The quotes can be based upon a single item, multiple lot sizes, and multiple items. The quoting system of the present invention can include, but is not limited to, some or all of the following, such as a pricing portion, specifications section, a materials section, a labor section, an additional costs section, a packaging section, an overhead section, and a selling price section. The software is adaptable to enable quotes to be provided for a multitude of circumstances. In other words, the software can function in any manner required by the user and can be adjusted in accordance with the specific needs of the user and can include additional sections as required.

The pricing portion of the software can be provided in a number of manners. For example, the pricing can be determined according to a per unit basis, a per thousand or hundred basis, based on dollar totals, based on thousand dollar totals, based on percentages, based on material specifications and cost input, net weight, flat dollar costs, and materials costs. Further, the pricing portion can distinguish between the costs of materials and the costs of labor, such that the two can be listed separately on the quote. The software also allows for the input of discounts, commissions, minimums, and markups. The software allows the user to select from a choice of price rounding methods commonly used in the industry.

The specifications section can automatically calculate gross weight and net weight per unit from specification input. A special feature section allows the user to input low and high tolerances of the required material. An average between the low and the high tolerances can become the value used in determining gross and net weights. Beyond the average tolerance, the user can input an alternative value for added safety on material costs. The alternative number can be used if it is between the average and high tolerances to protect the user from any costly mistakes.

The materials section automatically calculates the material cost. This section allows for price minimums and price discounts for different volumes of production. The gross weight amounts appear in this section to assist the user in asking for relevant pricing from suppliers. The gross weight is computed from the specification entries in the specification section.

The labor section automatically calculates labor costs. The section allows the user to input the hourly labor rates for the different job functions necessary for calculating labor costs. The supplemental Labor Rate Calculator provides the user a way to calculate productive hourly labor rates with designated input. The algorithm includes all wage-related costs and productive labor hours. The hours for the different job functions are broken down into two types. The first type of job functions is variable to production volumes. For multiple lot amounts being quoted, input is only required for the first lot amount. The other lot amounts are calculated automatically as a proration of the initial lot amount of input. The second type of job functions is semi-fixed for the different lot volumes in the quote item. Since each lot volume can differ, each lot volume amount must be entered individually.

The additional costs section automatically calculates the correct amount of additional costs for pricing based on input. The additional costs section offers flexibility in the different calculation methods different expenses. Costs are often quoted as a per unit price or a per weight unit price. The number of units and net weight for each lot volume appear on the form to assist the user when calling for quote information from suppliers. The net weight is calculated from the information inputted in the specification section. The costs can be inputted by unit price or weight unit price depending on the input. Minimum costs can be entered as well to determine the correct price. Scrap income is also calculated from the input of a scrap price per weight measure. The scrap value is included to more accurately reflect the total costs and benefits of the quoted project.

The packaging section automatically calculates the correct amount of containers for pricing based on input.

The overhead section offers multiple overhead methods including, but not limited to, overhead by labor dollar in percentage terms, overhead by labor hourly rate, overhead by equipment hourly rate by unit, price per unit (for amortization of upfront costs into the piece price), other dollar costs not expressed otherwise. These overhead methods offer the user a more complete manner in which to recognize indirect costs related to the part production.

The selling price section allows the user to override the price generated by the program. This “Final-Say in Price” feature does not necessarily have to be the final price. The software defaults to the larger of the two prices to protect the user from any costly mistake.

Another feature of the software is the creation of a budget for each job. When recording a job, the feature allows for the input of a different quantity (for the same sales price) than the amount quoted. Prorations based on the original quote amount allow the user to have a budget that is accurate for that job. An income statement is generated for each job and for each quote item. Budget reports are available that include all financial information as well as analysis regarding the job. In addition, another budget report is generated for the shop supervisor detailing the budgeted labor hours for all classifications on the specific job. The benefit of the budgeting is that companies can be able to compare the budget to the actual results, both financially and by labor hours. This promotes communication between the shop and the front office on what is reasonable in a quote. It enables the user to determine what aspects of accepted quotes were beneficial, what portion of the quote was underbid/overbid, and what aspects of the quote were inaccurate and thus cost the company money. Often, a company provides a quote and mistakenly does not accurately assess the costs associated with a project.

The software of the present invention enables a company to analyze the quotes previously provided such that the company can determine what portion of the quote was inaccurate. Therefore, the budgeting enables a company the ability to quickly and effectively analyze the accuracy of the quote and thus adjust future quotes to prevent the same inaccuracy.

Another feature allows the user to review all historical data regarding the quotes including requotes on each quote. Logs are available for any date range for quotes and jobs. The user can select sorting methods including but not limited to: customers, salesmen, and end user companies.

An additional feature of the software is the inclusion of tracking software. The tracking software compares the number of new jobs the user gets with the number of new quotes for any date range. The comparing of company-wide results from all other categories provides insight to management of where the company is doing well and where they can be wasting their time and resources. If the user can identify easily where there the success is management can direct resources to improving areas that were misquoted or underquoted. In other words, the tracking enables the company to determine the areas of business that are money-makers and money-wasters. Further, the tracking enables the company to determine the aspects of a quote that are repeatedly under or overpriced. This feature allows the user to sort database information by customer, salesman and end-user-company. A further sort of these choices allows for data by specific customer, top five customers, bottom five customers, and all customers. The same choices are available for salesmen and end-user-company. Also, time period analysis is available for all the same categories to recognize weekly, monthly or quarterly trends. This data is pure statistical information without the noise of whether one bid represented more dollars or not. The benefit is that this information is very reliable and much more immediate and precise than financial statements (or expensive consultants with dated and industry-generalized information). Financial statements actually blur a lot of costs together and it is antecedent to what is showing up in rising purchase orders relative to the amount of quoting. Therefore, a forward-looking manager would find this tool very useful. This can help to decide earlier in the business curve what types of business to sell to, what machines to buy, which salespeople are performing, and so on.

Requotes are not considered quotes for the jobs to quotes penetration analysis. The quote for a particular job is counted only once. At the same time, jobs received from requotes on jobs already in production are not considered jobs again for this analysis.

More specifically, the software can provide detailed analysis and charts that track bid penetration, accuracy of bid, and other desired criteria by customer, salesman, end user, and/or other desired category. The software can also provide an analysis for the user to determine breakeven analysis; budget hours per job, net profit, sales, costs per unit, and labor markups in dollars, hours, and percentages bases.

The software can also include security capabilities, thereby limiting who has access to the quoting software. Examples of software security systems are well known to those of skill in the art. The security device is any method of preventing access to the method and software absent the inclusion of an access code. The access code can be any code that can be used to access the software. Examples of such access codes include, but are not limited to, a PIN, an access code, a password, and a URL with an identification number.

The software can also include additional features without departing from the spirit of the present invention. Examples of such features include, but are not limited to, currency conversions (allowing costing in one currency and the bid in another currency), multiple processes, and inflation for multi-year contracts, inventory calculations, and links to other software systems or online systems. For example, the software of the present invention can include a linkage to accounting software already present at the end user's place of business. Alternatively, the software of the present invention can enable hyperlinks to be formed to websites.

Manufacturers must be innovative to get work when business is slow. Since lower quantities are more expensive to produce, sometimes manufacturers can double or triple the production volume and inventory the rest (waiting for the next order from the customer). The software of the present invention allows the user to see and select from the alternative production volumes. The sales price and anticipated selling price can be visible to assist in the final quote decision-making.

Additionally, the software includes the ability to compile the information inputted into the software and create charts based on any number of features. Features can include dates, salesperson, or other key feature. The software can also be connected to other software owned by the user. An example of such software is accounting software. By connecting the accounting software to the software of the present invention one can obtain a plethora of statistical data. The statistical data can be used to determine what costs can be cut or to provide more accurate quotes.

The attributes of the system of the present invention are numerous. For example, there is simplicity in input, unlimited quote items capability in one quote, and multiple quantities capability in one quote item. Stamping and tooling can be quoted and saved in the same quote item. The program also recognizes that stamping and tooling are most often linked to the same quote. Moving between the stamping and tooling parts of the quote can be done at the click of a mouse. The method calculates gross weight per unit and net weight per unit from specification information in metric or English measurements and provides flexibility in choosing from different methodologies in creating a quote. Interactive results from the input are shown directly on the forms, including selling price and anticipated profit.

The method provides accuracy in the computation and historical data stored in the system can be retrieved at any time. Additionally, budget information can be generated automatically for each job. Finally, users with passwords can enter the software from any geographic location simultaneously and security provides different levels of viewing ability for quoters and administrators.

The above discussion provides a factual basis for the method and software of the present invention as disclosed above. The methods used with a utility of the present invention can be shown by the following non-limiting examples and accompanying figures.

### EXAMPLES

### The Metal Stamping Quote System

### Home—Main Menu

1. Quote. Click the button
   A. To create a new quote, or,
   B. To select from a quote table any existing complete or incomplete quotes to perform different available functions. Functions include viewing, editing, purging and inactivating quotes.
2. Convert to job. Click button to open a list of complete quotes that are available to convert to a job.
3. Jobs List. Click the button to open a list of jobs.
4. ReQuote. Click the button to open a list of complete and incomplete requotes. Incomplete requotes can be accessed in the Quote or Requote section.
5. Tool. Click the button:
   A. To create a new tool to be assigned to a stamping quote item.
   B. To create a new tool not to be assigned to a stamping quote item.
   C. To select from a quote table any existing complete or incomplete tool quotes to perform different available functions.

Functions include viewing, editing, purging and inactivating quotes.
6. Report. Click the button to view and print:
   A. Individual (complete and incomplete) quote and budget information including extensive financial analysis. The reports include information on stamping and tooling.
   B. Statistical quote and job log information.
   C. Charts and tables showing the percentage of jobs penetration vs. quotes in any given period.
7. Admin. Click the button to open another selection to add or edit:
   A. Company Information. This refers to the user's company. The software allows for multiple companies in the same organization.
   B. Customer Information. This refers to the customers.
   C. End User Information. This refers to the ultimate end users of the products.
   D. Salesman Information. This refers to the salesmen.
   E. Application users. This refers to the users allowed to access the program.

### Getting Started—Creating a Quote

### Set Up Before Starting Quotes

If this is the first quote, a few items must be entered including Customer, Company, Salesman, and End User relevant to the quote. After inputting these database items the user can select them from a drop down on the quote forms.

Click Admin from Home or the drop down field above. After selecting Admin, select Customer, Company, Salesman, and/or End User to go the necessary screens to add the database information. The Company refers to the user's company. The program allows for multiple companies in one organization. The End User refers to the final customer of the product, such as Ford, General Motors or Daimler Chrysler. Once this data is entered, the user can select them from a simple drop down field in the quote screens.

### The Beginning and Ending of a Quote

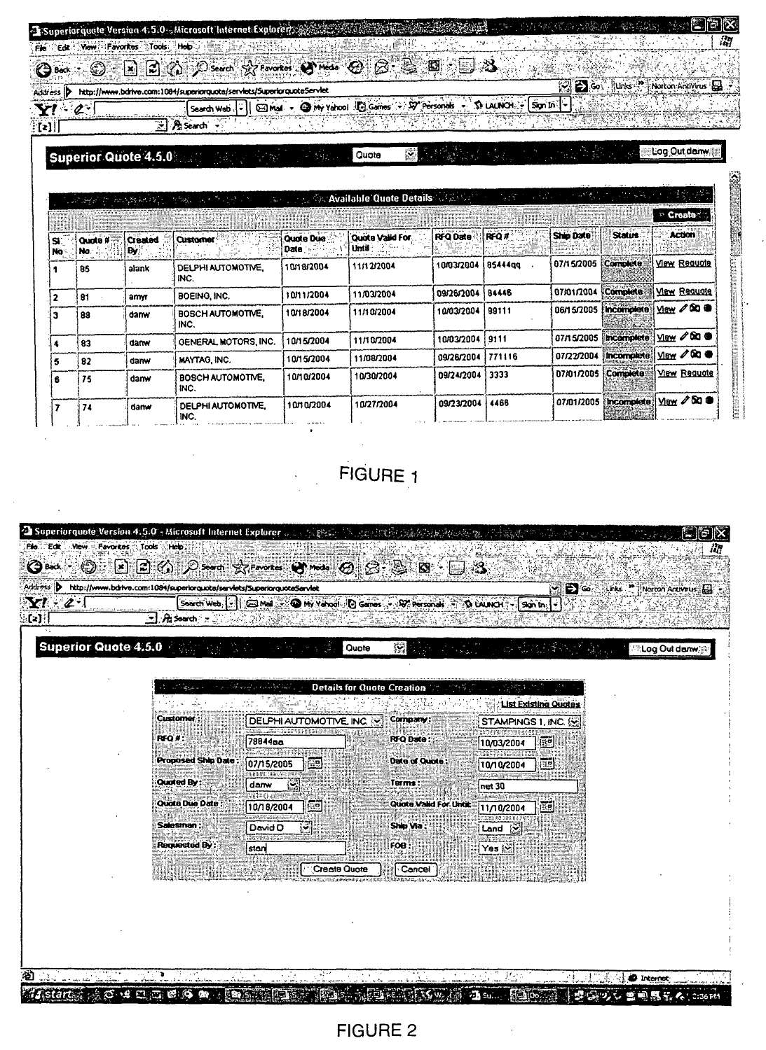

Once logged in, the Home Page of the program is entered. All of the main sections in the program can be accessed through the Home Page selections or the drop down field on the top of every screen. (See FIG. 1)

Click the Quote link to open the quote table. In this screen the user can select different available functions for creating a new quote, completing a quote-in-process or requoting a previously completed quote. Click the Create button in the upper right of the screen to begin quoting. (FIG. 2)

The Details for Quote Creation screen appears. If this is the first quote, see above Set Up Before Starting Quotes for set up required on database information. All dates can be selected from the calendar to the right of the date field or directly inputted as MM/DD/YYYY (include slashes when inputting). Use the drop down fields to select from the previously entered database information described above.

The Quoted By field should show the password. Passwords can be added in the Application User section in the Admin section. Passwords are further identified as User and Admin. User (such as the quoter) is only entitled to view his/her work or create new quotes. The Admin (management) can view each user's work as well. Once the information is complete, click Create Quote.

The Quote Details screen opens. Click the Choose Action drop down. Click Create New Item. The software allows the user to add an unlimited amount of quote items to be included in the same quote by using this drop down. Click Apply to begin the first quote item. Please note that each quote can include multiple quote items.

A new section opens on the screen. The general quote information remains on top of the screen to assist users during the quote process.

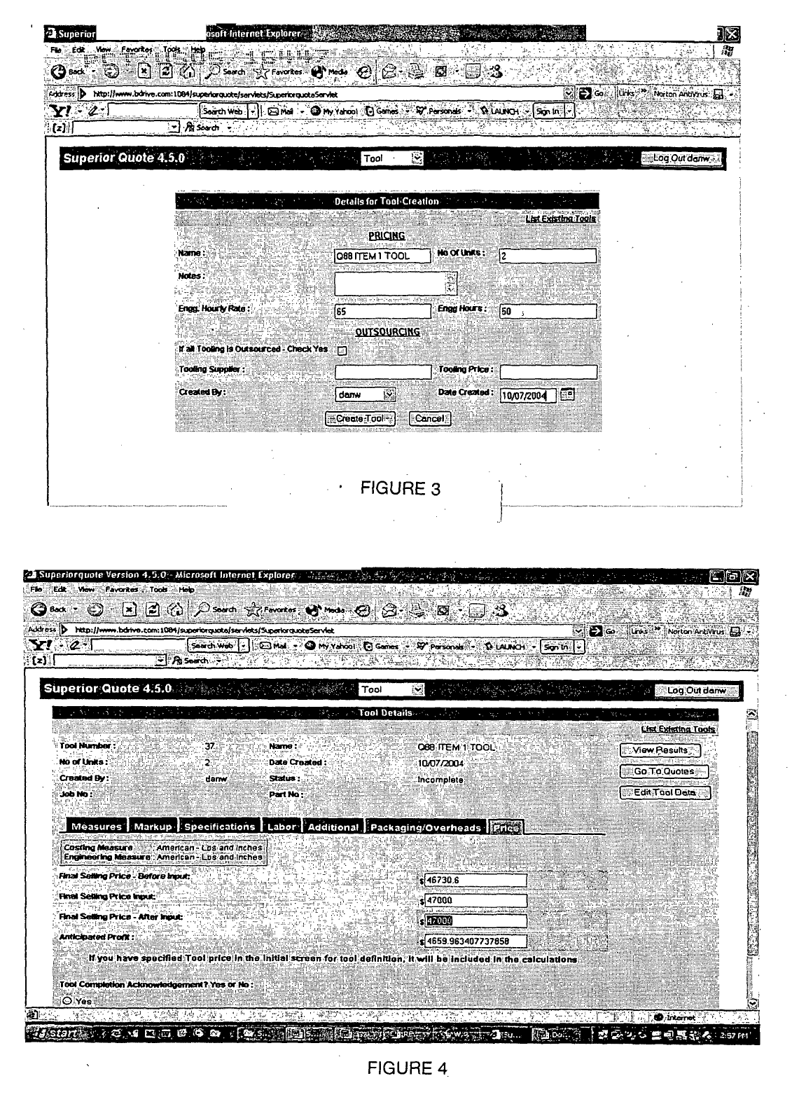

Follow the Stamping forms discussion later to assist in completing all the specific quote information. If this stamping product requires a tooling quote as well, click Go To Tools. (Tools can also be reached through the drop down at the top of the screen or through the Home Page (See FIG. 3)).

After completing the first page of the Tool information, click Create Tool. Similar to the Stamping section, the general tool information remains on top of the screen while a new section below opens to complete the Tool quote. Please follow the Tooling forms discussion later to assist in completing all the specific quote information. (FIG. 4)

Once the Tool information is complete, go to the Price tab. The user can put in an alternative selling price in the Final Selling Price Input field. This input can override the final selling price generated by the software only if it is higher.

Each quote item's stamping and tooling must be marked complete in order to classify the entire quote as complete. In addition, each quote must be marked complete in order to finalize the entire quote. Inside the Tooling Price section, click yes to Tool Completion Acknowledgment and click the save or calculate button below. This completes the Tooling side of the quote.

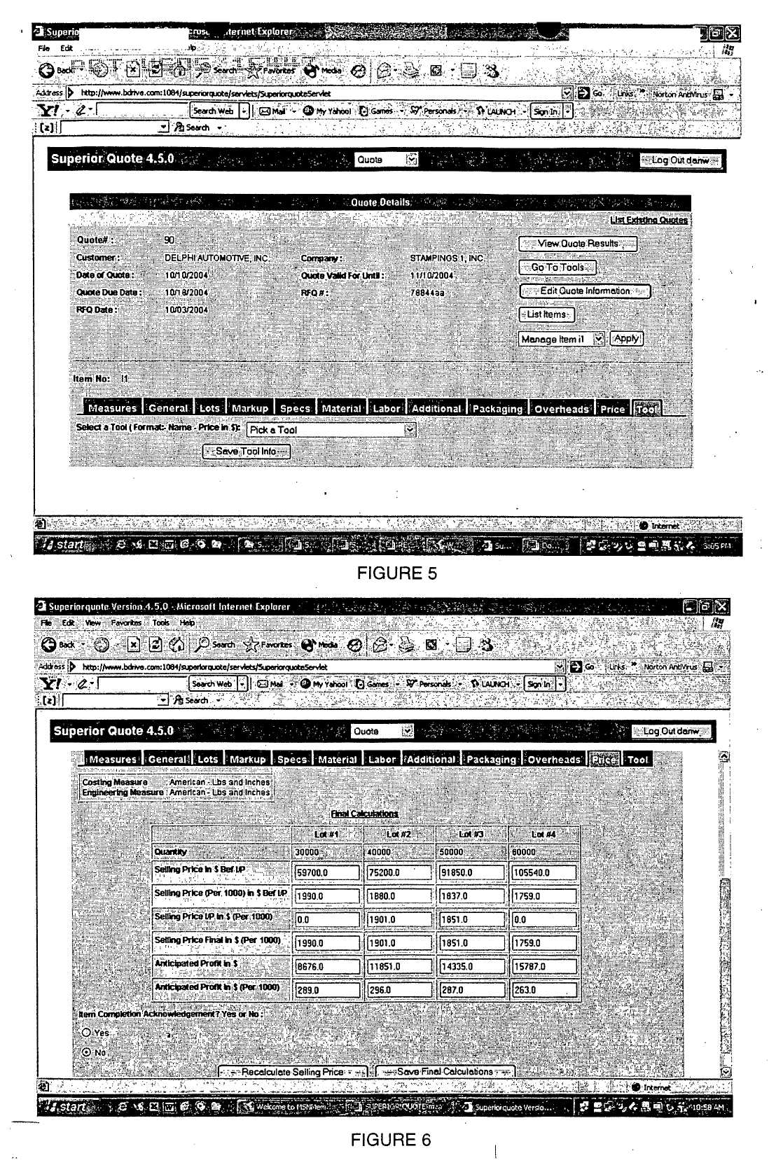

Return to Quote. The incomplete quote should appear on the Available Quote Details screen. Click the pen icon to edit the quote previously started. The Quote Details screen opens (FIG. 5). Click the Choose Action drop down. Click Manage Item 1. Click Apply to open the first quote item. Click the Tool tab in the Stamping quote information. Select the drop down Pick a Tool to link the tool quote to the Stamping quote. The Tooling description line appears in the drop down. Select the correct Tool to associate with the Stamping side of the quote item.

Once the Stamping information is complete, go to the Price tab (see following display). The user can input an alternative selling price (as expressed in per 1000 units method) for each lot amount in the Final Selling Price@m Input field. This input can override the final selling price generated by the software only if it is higher. (FIG. 6)

As noted above, each quote item's stamping and tooling must be marked complete in order to classify the entire quote as complete. Inside the Stamping Price section, click yes to Stamping Completion Acknowledgment and click the save or calculate button below. This completes the quote item.

If there is more than one quote item to be quoted in the entire quote, click Choose Action. Then click Create New Item in the drop down and hit Apply. This begins the entire quoting process for the next quote item within the larger quote to the customer. Repeat the steps to complete the next quote item. When all the quote items in entire quote are marked complete for both Stamping and Tooling, click Edit Quote Information button above.

The Quote Acknowledgment section opens (see FIG. 7). Click the Complete radio button. Then click Submit Changes. This completes the entire quote.

### Viewing Input and Reports for Quotes

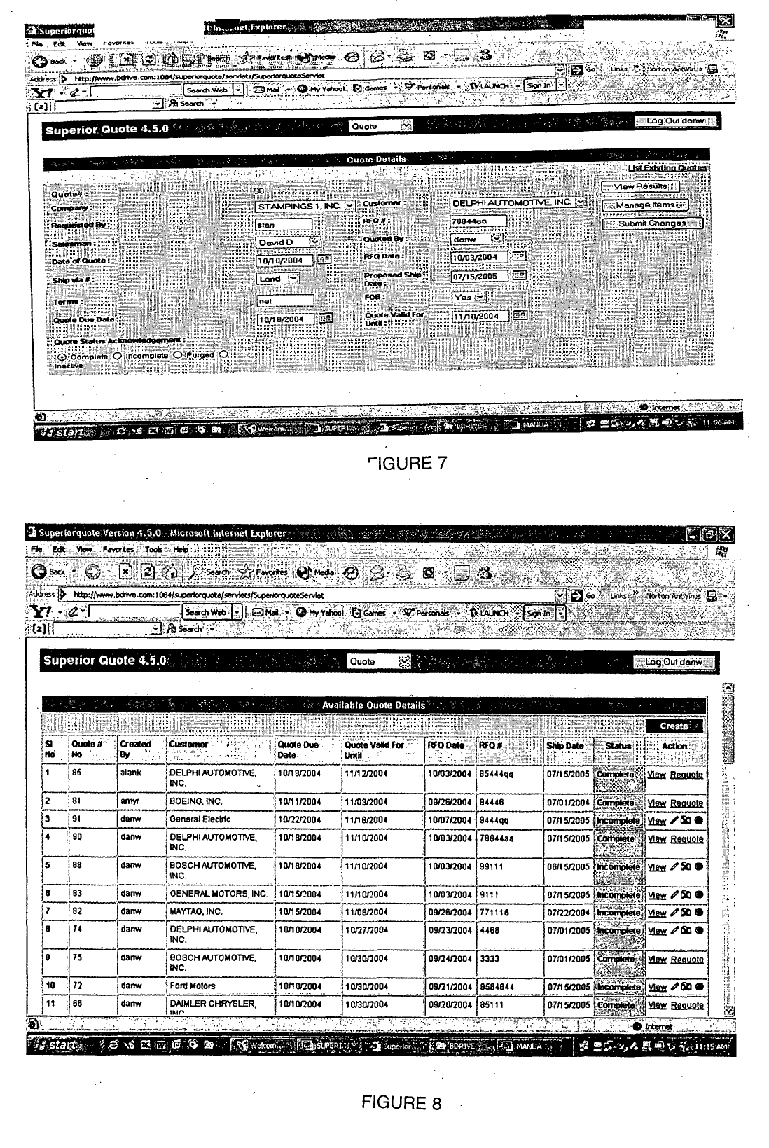

Once the quote is complete, the data is permanent for that quote. Historical information is kept as well as for any Requotes (to be explained below) based on the same basic data. Users are able to view their input and quote results. If the user wishes to view a complete quote, find the correct quote in the Quote table and click the word View in the Action column on the right. If the user wishes to view and/or print the quote information and analysis click Report from the Home Page or the drop down field at the top of the screen. (The Report information is available for incomplete quotes as well.) The Quote Information for any quote can be accessed in the Analysis tab inside Report(s). (See FIG. 8)

### Requiting a Previous Complete Quote

Sometimes the manufacturer has a need to requote a previous quote. The requote can be due to the request of the customer or the initiative by the manufacturer to economize the process. Regardless of the reason, any complete quote is a candidate for a requote.

Requotes can be created by first going in the Quote table (see previous display). Find the quote desired in the table, and then click the word Requote in the Action column to the right. The Select Items for ReQuote screen opens. Select the quote items to requote by using the check box. In addition, select Requote the Associated Tool by clicking the radio button. All previous data from the old quote will appear, making the requote a breeze. Just change the data that requires revision.

As explained in the Beginning and Ending of a Quote section previously, complete each quote item by clicking yes to Acknowledge Completion inside the Price tabs in the Stamping and Tooling quote forms. As explained in the Beginning and Ending of a Quote section previously, the entire quote is finished by clicking Edit Quote Information, then Complete, and then Submit Changes. The Requote is now complete. All information is retained in the system for both the old quote and the requote for future viewing and analysis.

Creating a Job from a Quote

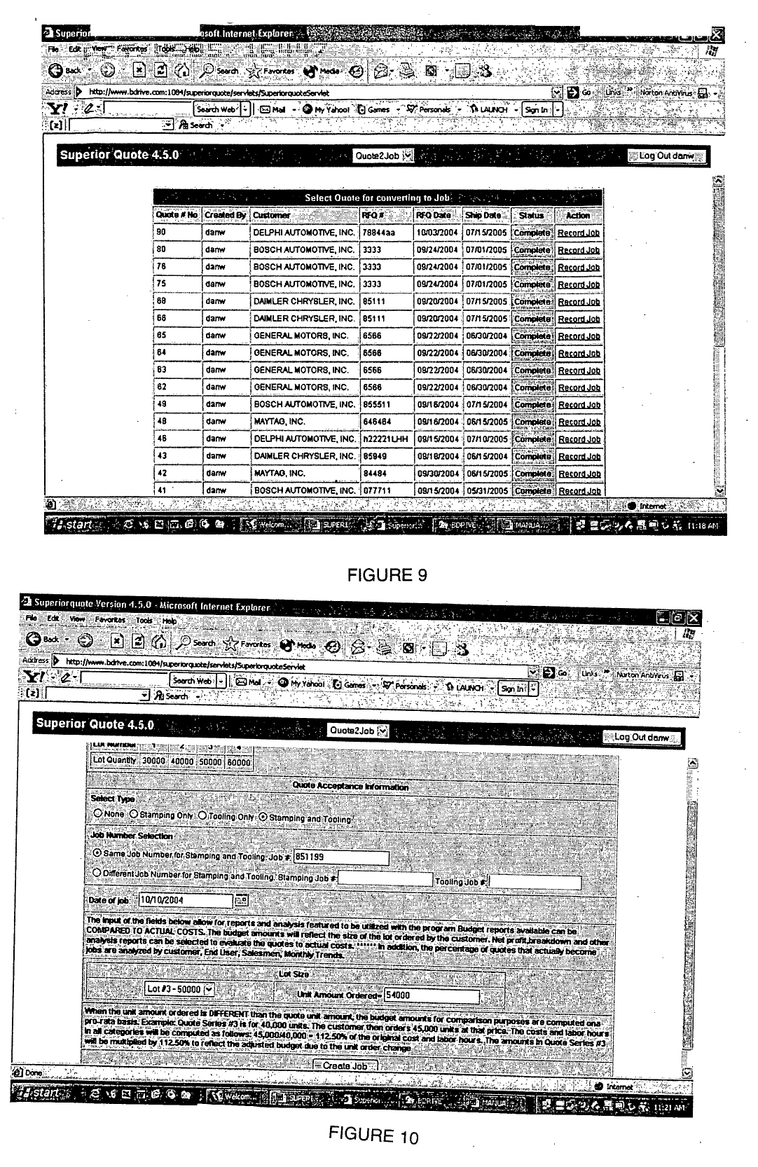

A complete quote (or requote) can be converted to a job after customer acceptance. (See FIG. 9) Record the new job as follows: Click on the Home Page the Convert to Job link, or, click Quote2Job on the drop down screen above; Find the correct quote, and click the words Record Job in the Action column to the right; The Select Items for Making Job screen opens; Click the check box next to the quote item that has been accepted by the customer for stamping and/or tooling; The Quote Acceptance Information screen appears; Complete the type of work selection, job number assignment, and, date of job in the screen; Select from the drop down field below the Lot Size selected by the customer determining the Final Selling Price for the stamping side of the quote; In the Unit Amount Ordered field, input the actual size ordered from the customer. This amount can differ from the quote item's lot size amount. This input creates budgets in hours and currency for planning and comparing to actual results; and finally, click Create Job. The job has been created and can be viewed at any time. Furthermore, substantial analysis is now available in the Jobs to Quotes tab inside Report(s). (See FIG. 10)

### Navigation

The tab key can be used to advance throughout the screens. In addition Shift Tab allows backward movement. The mouse can be used throughout as well. The quote tables show action icons next to the data. If the mouse hovers over the icon, a function message appears. Drop down fields allow the user to type in a letter to navigate directly to the choices starting with the letter. This speeds the selection process from the drop downs. The Home Page links and the drop down on the top bar provide access to every place in the program.

After inputting on the last screen for the quote item, the data must be saved before exiting. The last entered data can be saved by hitting any of the following: a save button; a calculate button; and a tab function key.

### Using the Quote Forms

Use the tabs to navigate through the different sections of the quote forms. All data is saved after input.

### Stamping Forms

### Details for Quote Creation

This section must be completed for every quote. All date fields can be inputted through the calendar selection or by typing in the actual date. All typed in dates must include slashes in this format—MM/DD/YYYY. Quoted By.

This must contain the password of the user. The security in the program will only show the quoters their own quotes. Administrators are able to see the other quoters as well as their own work. In order to add quoters or administrators, go to Admin then Application Users. Create Quote.

Click to begin the quote. This information can be edited later in the quote.

### Quote Details

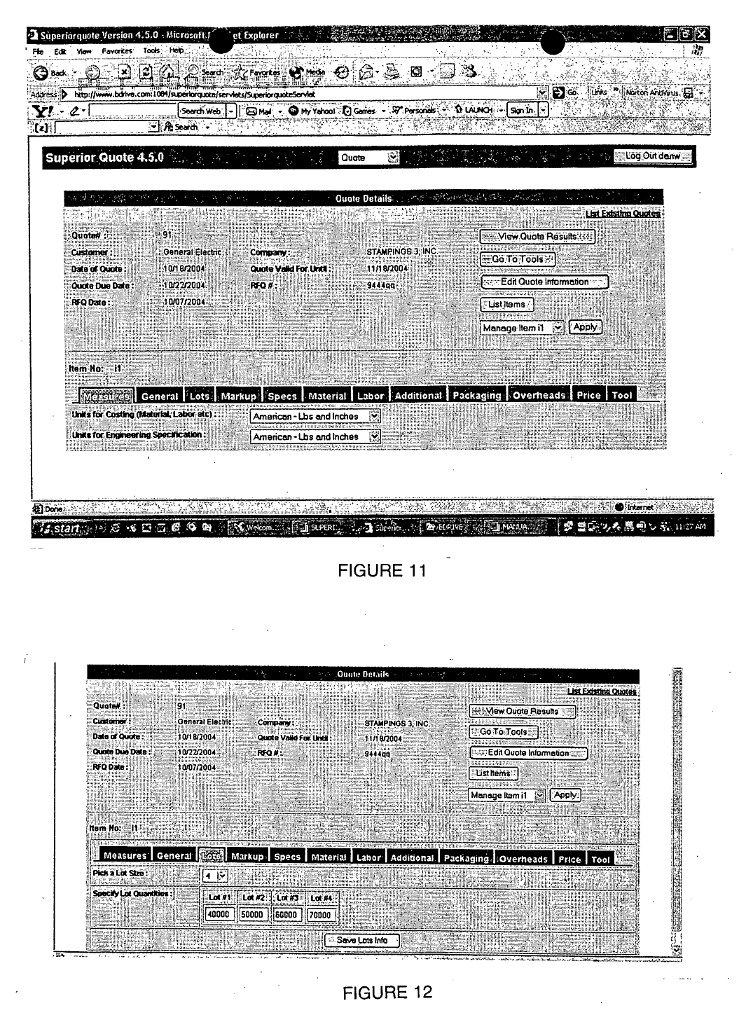

Quote details can be reviewed (FIG. 11), such details include the following:
1. View Results. Click button to view quote information
2. Go to Tools. Click to open the Tool quote section.
3. Edit Quote Information. This button will reopen the fields for editing.
4. Quote Status Acknowledgment. This radio button offers the following choices:
   a. Complete. Click to complete the quote. Each quote item's stamping and tooling must be marked complete in order to classify the entire quote as complete. In addition, each quote must be marked complete in order to finalize the entire quote. Inside the Price tab of both stamping and tooling quote forms is a field to mark the quote item complete.
   b. Incomplete. Default.
   c. Purge. If this is not meant to be a quote, it can be purged prior to completion.
   d. Inactivate. If this quote is not intended to go to customers it can be inactivated prior to completion. This allows the user to create quotes for planning purposes.
5. Submit Changes. Click after the selection in #4 to effect the changes.
6. Manage Items. Click to open the quote for the individual quote items.
7. Choose Action. Click to open drop down and select:
   a. Create New Item. Then click Apply to begin the quote item.
   b. Manage Item. Then click Apply to return to the quote item.

### Measures

Measures is the first tab in the Stamping and Tooling quote forms. The Units for Costing Measure refers to the unit of measure for costing. If the suppliers are costing in American pounds click the American choice in the drop down field. If the suppliers are costing in Metric kilograms, then click the Metric choice in the drop down field. Prices based on weight by suppliers must be inputted based on the correct unit of measure in the rest of the quote item information. If American is selected, all costs based on gross weight, net weight or scrap weight must be inputted in price per pound. If Metric is selected, all costs based on gross weight, net weight or scrap weight must be inputted in price per kilogram.

The Units for Engineering Measure refers to the unit of measure for specifications. Simply click the drop down field and select either American or Metric. If American is selected, all specifications must be inputted (and reported) in pounds and inches. If Metric is selected, all specifications must be inputted (and reported) in kilograms and centimeters.

The unit of measure for Costing and Engineering appear on every quote form screen to assist the user in the quote process (and prevent a costly mistake).

### General Information

The General Information in this section refers to the specific quote item.
1. Part Number. Enter Part number using numbers, letters or any other characters.
2. Cad File Number. Enter Cad File number using numbers, letters or any other characters. End User. End User refers to the final buyer in the manufacturing process. Examples in the automotive industry are General Motors, Ford, and Daimler Chrysler. This input will provide very useful management information reports to be explained later. Select from the drop down field the end user. (In order to add to the End User list, go to Admin, and then End User.)

### Quote Lot Amounts

This section must be filled in for results. (See FIG. 12) Pick a lot size. Pick from the drop down up to 10 Lot amounts to quote at the same time. The program allows for 10 volume amounts to be quoted simultaneously. The user must enter the number of units for bidding starting with the first column to the left.

### Mark-ups (FIG. 13)

1. Material Percentage of Mark-Up. Enter percentage of material markup for stamping.
2. Final Percentage of Mark-up. Enter percentage of final markup stamping.
3. Commission Percentage. Enter commission percentage for stamping.
4. Select One-Rounding Sales Price Per 1000 Units. Select the method of rounding desired for the final price.

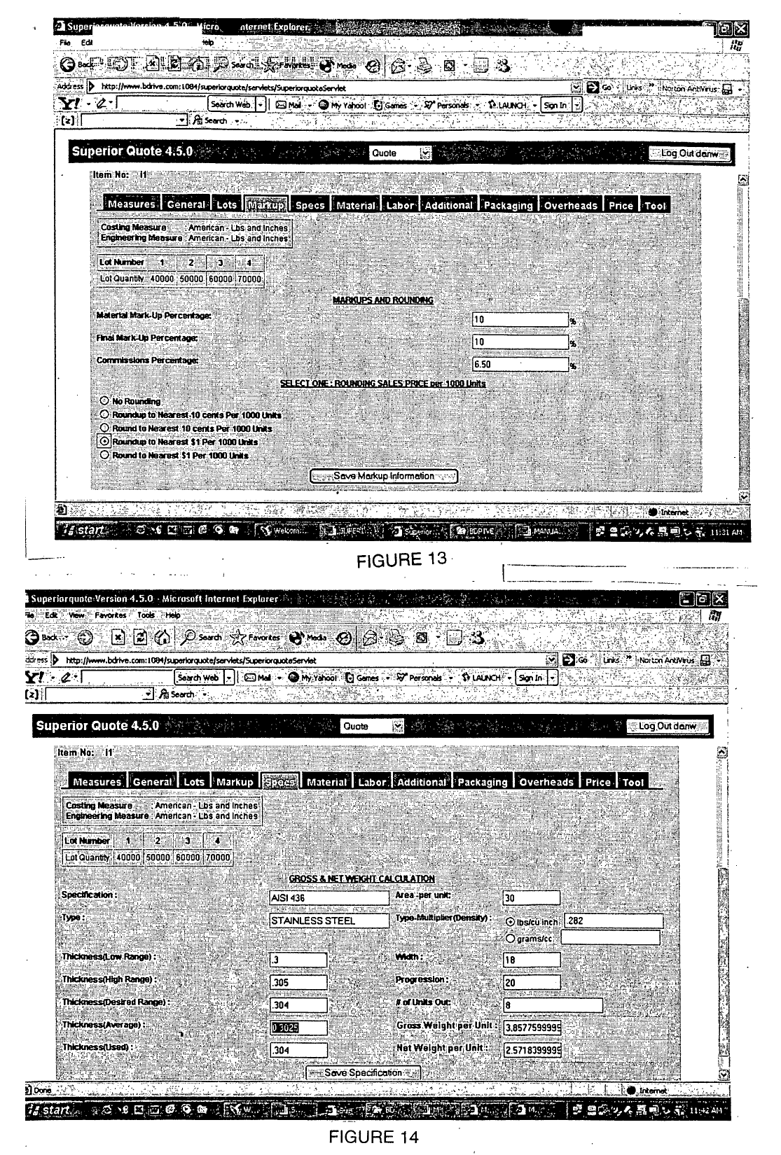

### Specifications (FIG. 14)

All material and additional cost calculations that are priced in terms of weight require specification entries. The specification entries must conform to the American or Metric Measure designation selected in the first quote item tab in the quote forms. If there is an American designation, input must be in inches with the accompanying weight result shown in pounds. If there is a Metric designation, input must be in centimeters with the accompanying weight result shown in kilograms. The only exception to this rule is in the Density field that allows either American or Metric equivalents. This is intended to simplify the quoter's job. (Density values for materials (as well as other properties) can be found in the website: www.matweb.com.)

In order to complete this section the following steps must be completed:
1. Specification. Enter the numerical metal specification (such as 1008/1010).
2. Type. Enter the name of the metal specification (such as stainless steel, brass, etc.)
3. Thickness-Low Range and High Range. Enter the thickness tolerances allowed using the correct Engineering Measure (inputted in Measures). The Measures appear on every quote form page to simplify inputting for the user.
4. Thickness Average. No entry. This provides the halfway point between the low and high ranges. The average thickness (the default calculation) is used to compute the material weight unless there is a higher thickness amount entered in Thickness-Desired.
5. Thickness-Desired. Optional entry. See Thickness Average explanation. The Thickness-Desired overrides the Thickness Average when the amount is greater than the average and less than or equal to the Thickness-High range.
6. Thickness Used. No entry. This field is calculated from the information contained in Thickness-Low Range and High Range, Thickness Average, and Thickness-Desired. The average thickness (the default calculation) is used to compute the material weight unless there is a higher thickness amount entered in Thickness-Desired. If the Thickness-Desired is higher than the average and not greater than the high range, the Thickness-Desired amount is the Thickness-Used.
7. Area-per Unit. Enter the area of the part (from CAD work).
8. Density—Type Multiplier. Select either American or Metric for the density multiplier. When choosing the American density selection, enter pounds per cubic inch for the metal (such as 0.2833). When choosing the Metric density selection, enter the grams per cubic centimeter. Either entry calculates the proper weight regardless of whether the other engineering specifications are in either American or Metric.
9. Width. Enter width of entire plate.
10. Progression. Enter progression (length) of entire plate.
11. Number of Units Out (Default=1). Enter the number of units being made from the same tool or die in one punch of the metal. If the answer is 1, no entry is required.
12. Gross Weight Unit. No entry. Note if the gross weight is less than the net weight, there is an input error in the Specifications section.
13. Net Weight Unit. No entry. Note if the gross weight is less than the net weight, there is an input error in the Specifications section.

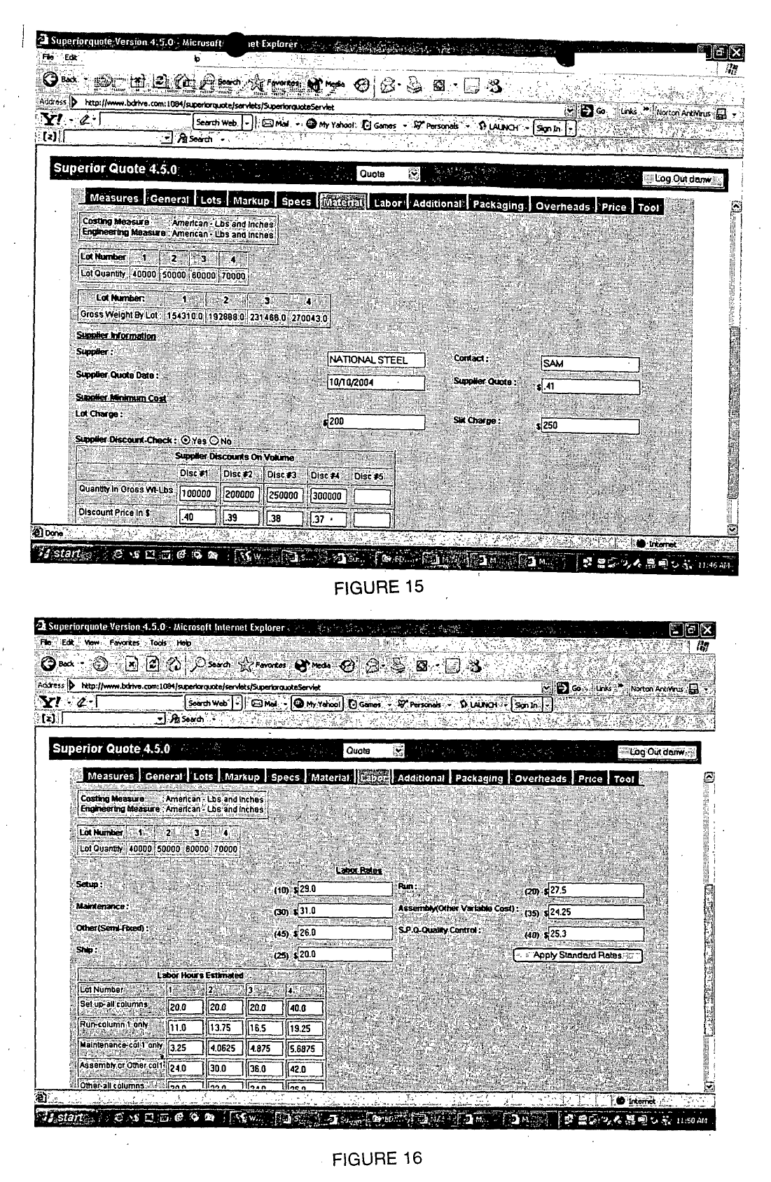

### Materials (FIG. 15)

All computed gross weight amounts relates to the Quantities Quoted showing in the same column. This section requires input for material pricing per Costing weight measure designated in the Unit of Costing Measure. Discounts for large volumes and minimums for small volumes are offered in the material calculations. In order to obtain the cost the following steps must be performed:
1. Supplier Quote. Input the price.
2. Supplier Discount-Check for Yes. Check to enter discount information.
3. Quantity in Gross Weight (for discounts). Enter the quantities in lbs. the discount volume levels. Example: Buying 50,000 lbs. the price is $0.40 vs. the regular price of $0.410. Up to 5 discount levels allowed.
4. Discount Price per Weight Measure. Enter the price related to the Quantity in Gross Weight (for discounts) entered above.
5. Lot Charge. Enter minimum charge if applicable.
6. Slit charge. Enter minimum charge if applicable.
7. Calculate Material Costs. Click button to view window with calculated material cost totals. Close window with click of upper right x in window.

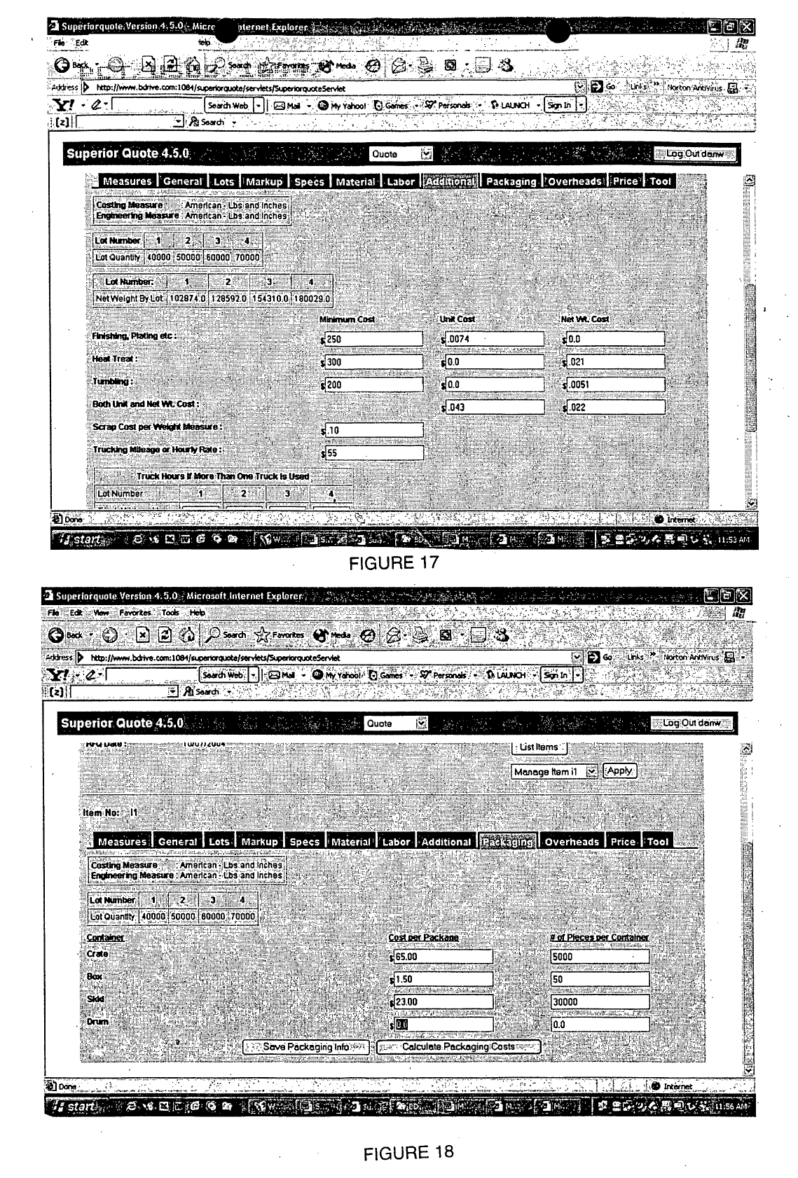

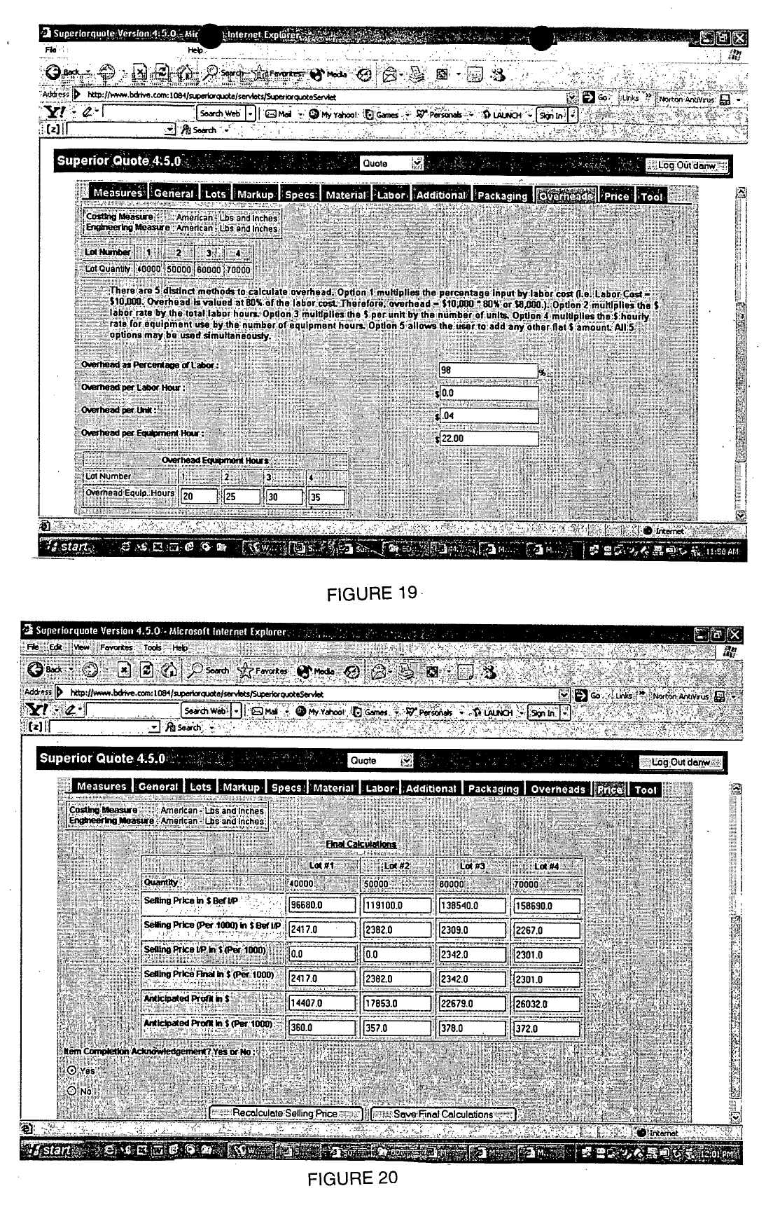

### Labor Computation (FIG. 16)

In order to obtain the cost for labor the following steps must be performed:
1. Labor Quote Rates (all classifications). Enter labor rates per hour for all classifications.
2. Labor Hours Estimated. Enter estimated labor hours for each classification applicable. Totally variable labor classifications (Run, Maintenance, and Assembly or Other) require input for the first volume only.
3. Calculate Variable Costs. Click button to view calculated labor hours.

### Additional Costs (FIG. 17)

Some costs are calculated on net weight. The pricing must be based on the selected Unit of Costing Measure. If the measure is metric, then prices should be based per kilogram. If the measure is American, then prices should be based per pound. There is a choice of pricing in either per unit or per weight measure, along with any flat dollar amounts.
1. Net Weight By Lot. No entries. The net weight is computed from the input in the specification section.
2. Minimum Costs. Enter if applicable for Finishing, Heat Treat, and/or Tumbling.
3. Unit Cost and/or Net Weight Cost. Finishing, Heat Treat, Tumbling and/or Other allow input for either price method.
4. Scrap Cost per Weight Measure. Enter price expected to receive for scrap.
5. Trucking Hourly or Mileage Rate. Enter trucking rate.
6. Truck Miles or Hours. Enter miles or hours for each lot amount.
7. Trucking Dollars. Enter additional dollar costs for trucking (such as a truck rental). Input costs related to the Lot Quantity above.
8. Other Dollars. Enter additional dollar costs for classifications not shown. Input costs related to the Lot Quantity above.
9. Calculate Additional Costs. Click button to view window with calculated additional cost totals. Close window with click of upper right x in window.

### Packaging (FIG. 18)

In order to obtain the cost of packaging the following steps must be performed:
1. Packaging—Cost per Container. Enter applicable costs for different types of packaging. The user can use all, one, or none of the types of packaging.
2. Packaging—Number of Pieces Per Container. Enter the estimated number of pieces to fill each type of container applicable.
3. Calculate Packaging Costs. Click button to view window with calculated packaging cost totals. Close window with click of upper right x in window.

### Overhead (FIG. 18)

The program allows for 5 different types of overhead methods. The methods can be used individually or at the same time.

Overhead as Percentage of Labor. Enter overhead as a percentage of labor. This is perhaps the most common method to apply overhead but certainly not the only one.

Overhead Dollars per Labor Hour. This method is sometimes used instead of percentage of labor. If used in conjunction with the Overhead as a Percentage of Labor, it can localize the cost for a new facility. Example: The Company buys a new plant and expects the purchase price to be paid back in five years. By estimating the total hourly use over five years, an hourly labor rate can be determined and used to match the cost with the locale. Using this approach, parts made in the new facility pays for the new facility.

Overhead Dollars per Unit. This can be used in addition to other overhead methods. This overhead method can be used to convert upfront tooling costs into a piece price.

Overhead Dollars per Equipment Hours. This can be used in addition to other overhead methods. This overhead method can localize the cost of a major machine purchase. Example: Similar to Overhead Dollars per Labor Hour, the Company buys a new machine and expects the purchase price to be paid back in five years. By estimating the total hourly use over five years an hourly machine rate can be determined and used to match the cost with the machine to the jobs that use the machine directly. Using this approach, parts made with a new machine pays for the new machine.

Overhead—Other Dollars. This can be used in addition to other overhead methods. This can be used to satisfy any other overhead costs that are applied to the quote item.

Calculate Overhead Costs. Click button to view window with calculated packaging and overhead cost totals. Close window with click of upper right x in window.

### Price (FIG. 20)

The selling price section shows the results of all input in terms of selling prices, anticipated profits and an opportunity to input a higher price over the computed price. One distinct feature allows the user to input another price over the computer-generated price. (See Selling Price@m-INPUT).
1. Selling Price Dollars Before INPUT. No entry. These are the total selling prices for all volumes before user's optional input price below.
2. Selling Price@m Before INPUT. No entry. These are the total selling prices per 1,000 units for all volumes before user's optional input price below.
3. Selling Price@m—INPUT. Entry optional. Input any optional prices desired expressed as per 1,000 units. If the input price is larger than the program-generated price, the input price becomes the Selling Price Final-@m. If the input price is lower than the program-generated price, the program-generated price becomes the Selling Price Final-@m. The override feature on the override is intended to save the user from a costly mistake.
4. Selling Price Final-@m. No entry. See Selling Price@m—INPUT explanation above.
5. Anticipated Profit-Dollars. No entry. Displays anticipated profit in dollars.
6. Anticipated Profit-@m. No entry. Displays anticipated profit per 1,000 units.
7. Stamping Completion Acknowledgment. Each quote item's stamping and tooling must be marked complete in order to classify the entire quote as complete. Click yes to Stamping Completion Acknowledgment and click the save or calculate button below. This completes the quote item.

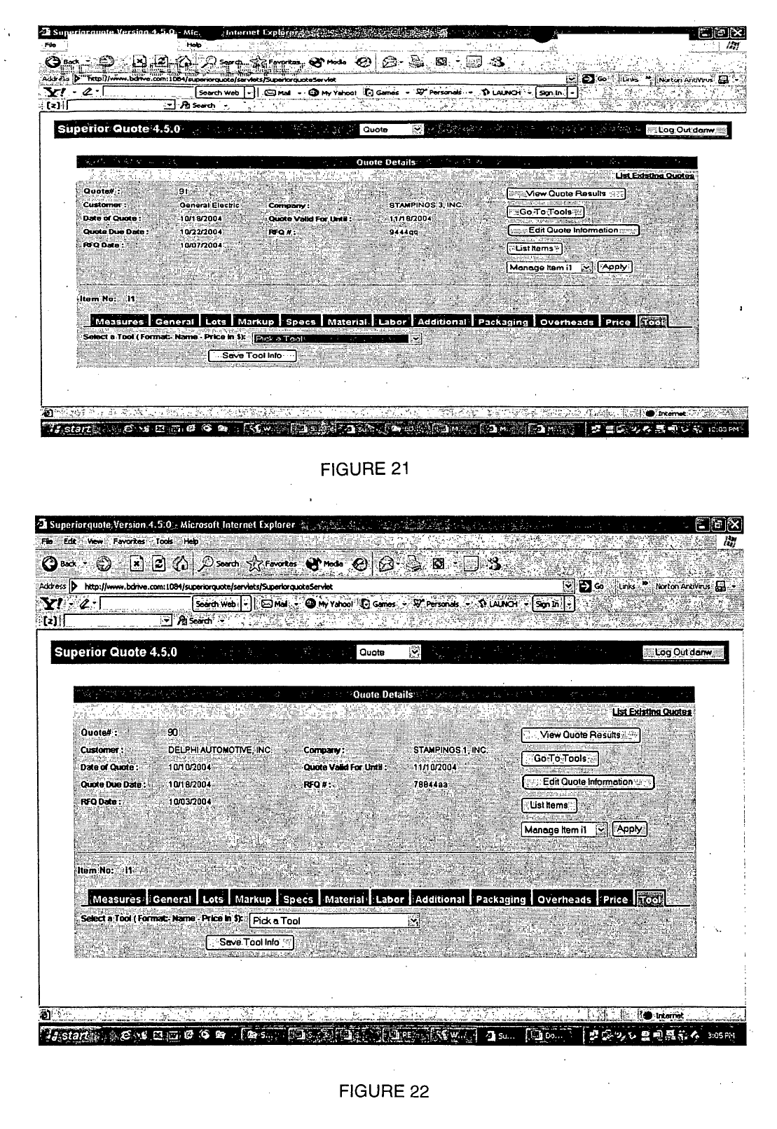

### Tool (in the Stamping Quote Section) (FIGS. 20 and 21)

This section links the Tool side of the quote to the stamping side of the quote. If no tool quote has been started go directly to the Tool Quote section. Select the correct tool to associate with the stamping quote item currently being worked on.

### Tool Forms (FIG. 22)

This section relates to the tooling side of the stamping quote. See 5a14 above detailing how to link the tool with the stamping quote. Tool quotes can also be created without a stamping quote.

### Details for Tool Creation

1. Name. Describe the quote so that it can be identified in the Pick a Tool drop down in the stamping quote section for linking.
2. Engineering Hourly Rate-Dollars. Enter engineering rate per hour.
3. Engineering Hours. Enter estimated engineering hours.
4. Number of Units. Enter the number of tools or dies.
5. Created By. Be sure that the password appears in the field.
6. Date Created. This can be inputted using the calendar or by typing in the field. Typed dates require slashes as follows: MM/DD/YYYY.
7. If All Tooling is Outsourced—Check Yes. This pertains to a tool job that is outsourced entirely.
8. Create Tool. Click to create a tool.

### Tool Details

1. Edit Tool Data. Click to edit the Details for Tool Creation.

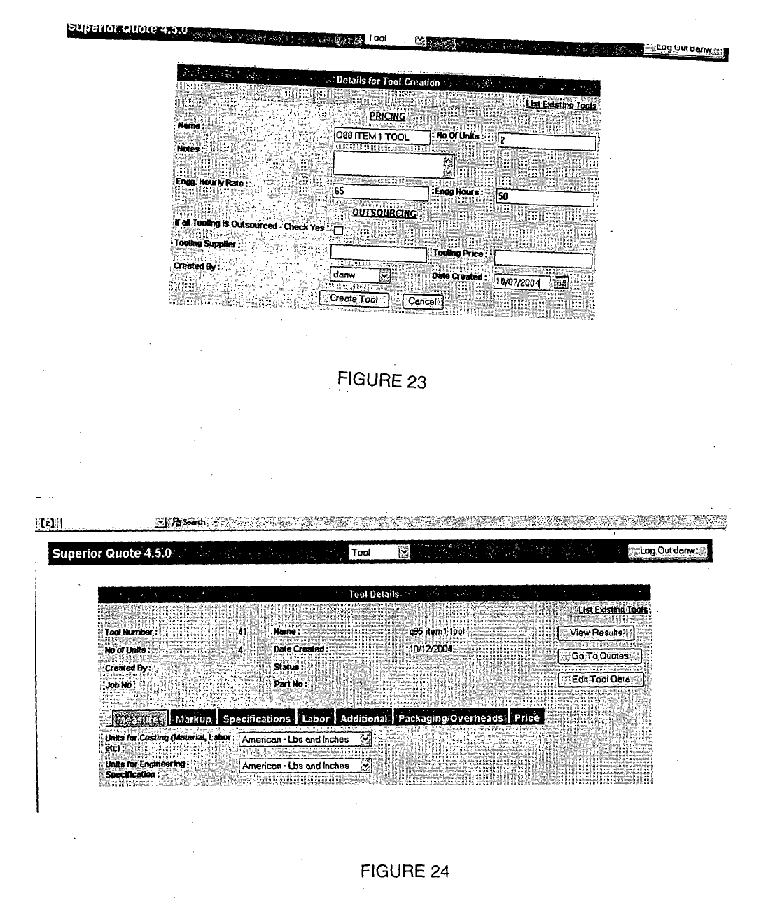

### Measures (FIG. 23)

Measures is the first tab in the Stamping and Tooling quote forms.
1. The Units for Costing Measure refers to the unit of measure for costing. If the suppliers are costing in American pounds click the American in the drop down field. If the suppliers are costing in Metric kilograms, then click Metric in the drop down field. Prices based on weight by suppliers must be inputted based on the correct unit of measure in the rest of the quote item information. If American is selected, all costs based on gross weight, net weight or scrap weight must be inputted in price per pound. If Metric is selected, all costs based on gross weight, net weight or scrap weight must be inputted in price per kilogram.
2. The Units for Engineering Measure refers to the unit of measure for specifications. Simply click the drop down field and select either American or Metric. If American is selected, all specifications must be inputted (and reported) in pounds and inches. If Metric is selected, all specifications must be inputted (and reported) in kilograms and centimeters.
   The unit of measure for Costing and Engineering appear on every quote form screen to assist the user in the quote process (and prevent a costly mistake).

### Mark-Ups (FIG. 24)

In order to obtain the mark-up cost the following steps must be performed:
1. Material Percentage of Mark-Up. Enter percentage of material markup for tooling.
2. Final Percentage of Mark-up. Enter percentage of final markup tooling.
3. Commission Percentage. Enter commission percentage for tooling.
4. Select One-Rounding Method. Select the method of rounding desired for the final price.

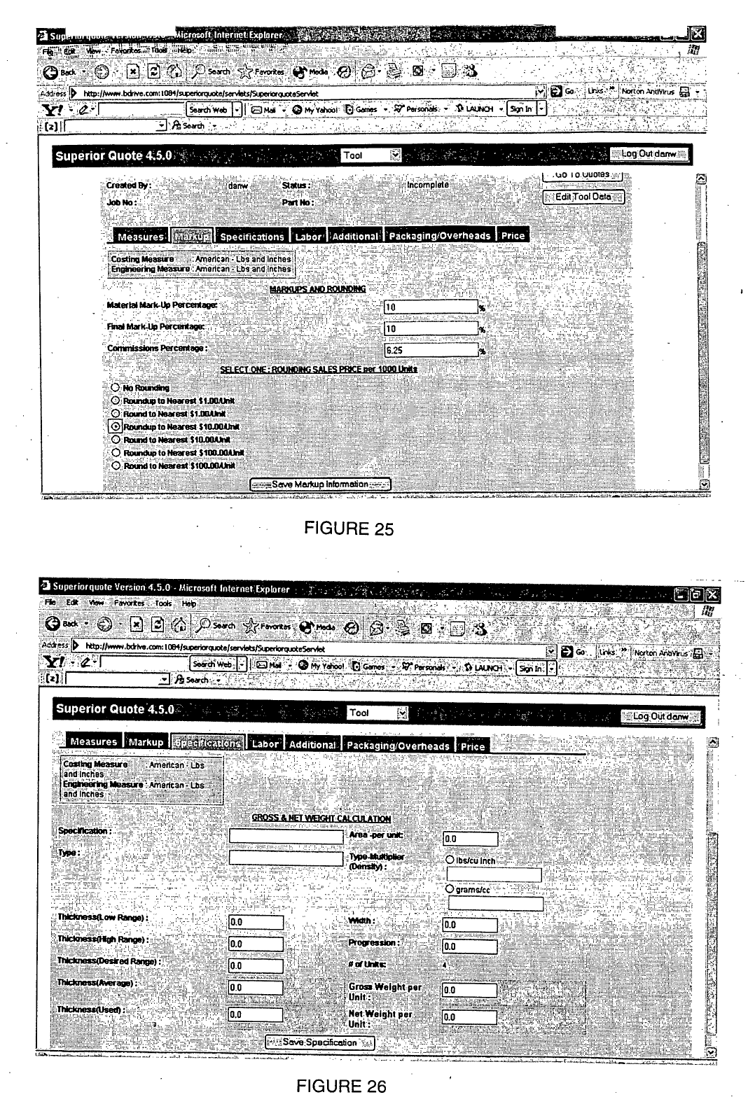

### Specifications (FIG. 25)

All material and additional cost calculations are priced in terms of weight require specification entries. The specification entries must conform to the American or Metric Measure designation selected in the first quote item tab in the quote forms. If there is an American designation, input must be in inches with the accompanying weight result shown in pounds. If there is a Metric designation, input must be in centimeters with the accompanying weight result shown in kilograms. The only exception to this rule is in the Density field that allows either American or Metric equivalents. This is intended to simplify the quoter's job.
1. Specification. Enter the numerical metal specification (such as 1008/1010).
2. Type. Enter the name of the metal specification (such as stainless steel, brass, etc.)
3. Thickness-Low Range and High Range. Enter the thickness tolerances allowed in inches.
4. Thickness Average. No entry. This provides the halfway point between the low and high ranges. The average thickness (the default calculation) is used to compute the material weight unless there is a higher thickness amount entered in Thickness-Desired.
5. Thickness-Desired. Optional entry. See Thickness Average explanation. The Thickness-Desired overrides the Thickness Average when the amount is greater than the average and less than or equal to the Thickness-High range.
6. Thickness Used. No entry. This field is calculated from the information contained in Thickness-Low Range and High Range, Thickness Average, and Thickness-Desired. The average thickness (the default calculation) is used to compute the material weight unless there is a higher thickness amount entered in Thickness-Desired. If the Thickness-Desired is higher than the average and not greater than the high range, the Thickness-Desired amount is the Thickness-Used.
7. Area-per Unit. Enter the area of the tool.
8. Density—Type Multiplier. Select either American or Metric for the density multiplier. When choosing the American density selection, enter pounds per cubic inch for the metal (such as 0.2833). When choosing the Metric density selection, enter the grams Per cubic centimeter. Either entry calculates the proper weight regardless of whether the other engineering specifications are in either American or Metric.
9. Width. Enter width.
10. Progression. Enter length.
11. Gross Weight Unit. No entry. Note if the gross weight is less than the net weight, there is an input error in the Specifications section.
12. Net Weight Unit. No entry. Note if the gross weight is less than the net weight, there is an input error in the Specifications section.

### Material for Tooling

In order to determine the material required for tooling the following steps must be performed:
1. Gross Weight of Tooling. No entry.
2. Supplier Material-Price/Weight Measure. Enter price per pound or kilogram depending on the Costing Measure (American pounds or metric kilograms) selected in Measures (and appearing on screen).
3. Material Minimum Price. Enter if applicable.

### Labor or Outsourced Pricing (FIG. 26)

In order to obtain the labor or outsourcing price the following steps must be performed:
1. Labor Quote Rates (all classifications). Enter labor rates per hour for all classifications.
2. Labor Hours Estimated. Enter estimated labor hours for each classification applicable.
3. Outsourced Price-Dollars. Enter all outsourced prices for each classification when applicable.

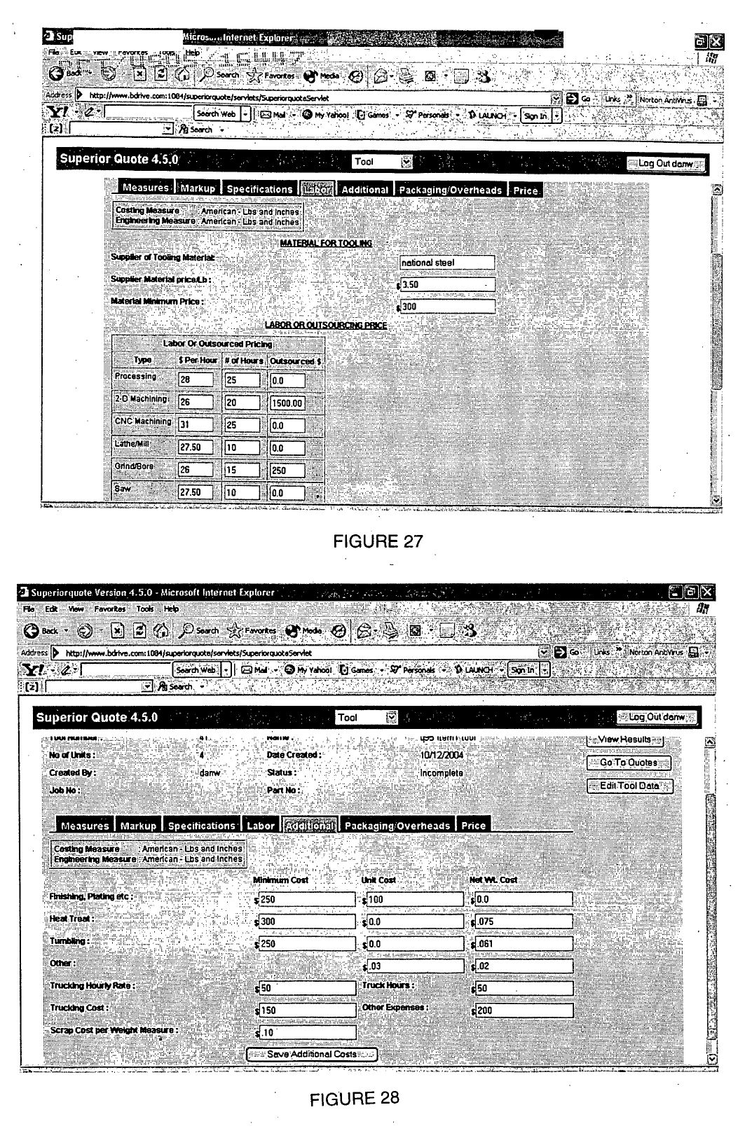

### Additional Costs (FIG. 27)

In order to determine any additional costs the following steps must be performed:
1. Net Weight. No entry. The net weight is computed from the input in the Measures and Specification sections.
2. Minimum Costs. Enter if applicable for Finishing, Heat Treat, and Tumbling.
3. Unit Cost or Net Weight Cost. Finishing, Heat Treat, and/or Tumbling allow input for one price method only. Other allows for input using both methods. The Other field can be used for any cost priced by using per unit or per weight costs.
4. Trucking Mileage or Hourly Rate. Enter the trucking rate.
5. Trucking Dollars. Enter additional dollar costs for trucking (such as a truck rental).
6. Other Dollars. Enter additional dollar costs for classifications not shown.

### Packaging and Overhead (FIG. 28)

1. Packaging—Cost per Container. Enter applicable costs for different types of packaging. The user can use all, one, or none of the types of packaging.
2. Packaging—Number of Pieces Per Container. Enter the estimated number of pieces to fill each type of container applicable.
3. Overhead as Percentage of Labor. Enter overhead as a percentage of labor. This is perhaps the most common method to apply overhead.
4. Overhead Dollars per Labor Hour. This method is sometimes used instead of percentage of labor. If used in conjunction with the Overhead as a percentage of Labor, it can localize the cost for a new facility. Example: The Company buys a new plant and expects the purchase price to be paid back in five years. By estimating the total hourly use over five years, an hourly labor rate can be determined and used to match the cost with the locale. Using this approach, tools made in the new facility pays for the new facility.
5. Overhead Dollars per Unit. This can be used in addition to other overhead methods.
6. Overhead Dollars per Equipment Hours. This can be used in addition to other overhead methods. This overhead method can localize the cost of a major machine purchase. Using this approach, tools made with the new machine pays for the new machine.

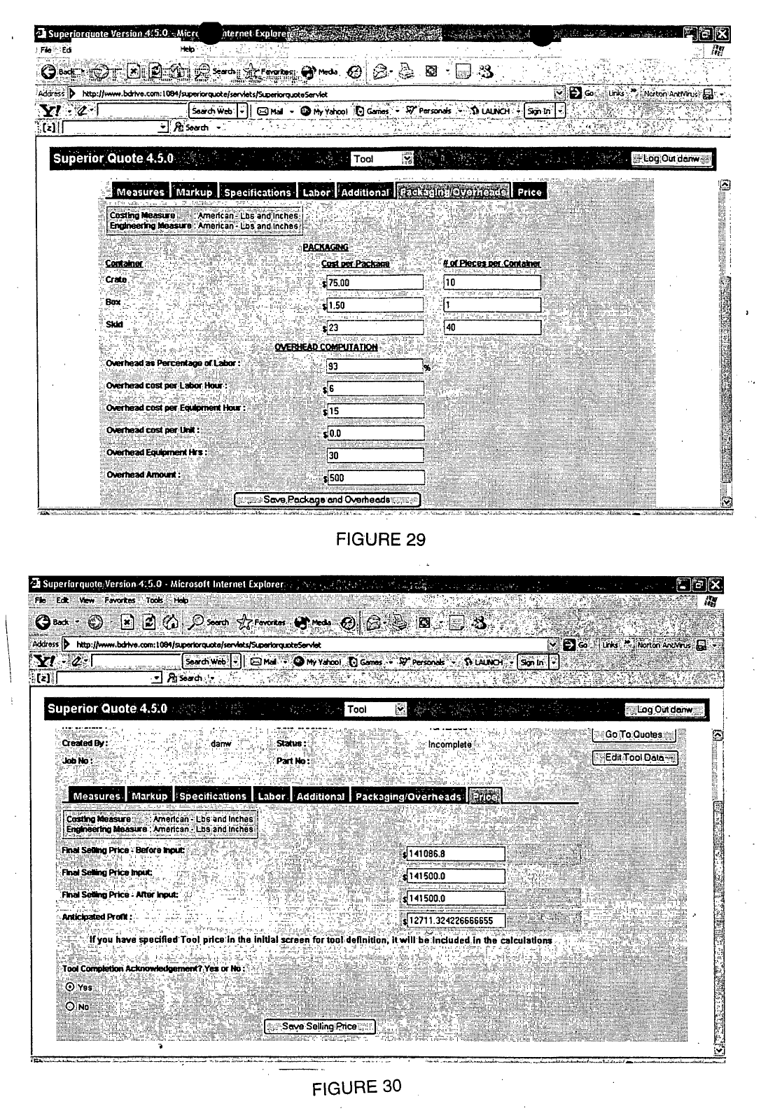

### Price (FIG. 29)

The selling price section shows the results of all input in terms of selling prices, anticipated profits, and an opportunity to input a higher price over the computed price.
1. Selling Price in Dollars Before INPUT. No entry. This is the total selling price before user's optional input price below.
2. Selling Price Final—INPUT. Entry optional. Input any optional price desired expressed as per unit. If the input price is larger than the program generated price, the input price becomes the Selling Price Dollars After INPUT. If the input price is lower than the program generated price, the program generated price becomes the Selling Price Dollars After INPUT.
3. Selling Price Dollars After INPUT. No entry. See Selling Price Final—INPUT explanation above.
4. Selling Price Final-Dollars. No entry. See Selling Price Final—INPUT explanation above.
5. Anticipated Profit-Dollars. No entry. Displays anticipated profit in dollars.
6. Tool Completion Acknowledgment. Each quote item's stamping and tooling must be marked complete in order to classify the entire quote as complete. Click yes to Tool Completion Acknowledgment and click the save or calculate button below. This completes the quote item.

### Stamping and Tooling (FIG. 30)

### Convert to Job

The quote must be complete prior to converting to a job.
1. Select One (stamping, tooling, or stamping and tooling). Select which part of the bid was accepted.
2. Select One—Quote Lot Size Ordered. Select the column number of the accepted price per 1,000. See explanation in form.
3. Unit Amount Ordered. Enter the actual amount ordered if different than the amount of the quote. See explanation in form.
4. Stamping and Tooling Job Number. If the stamping and tooling job numbers are the same, input one job number. If the stamping and tooling job numbers are the different, input job numbers for both.

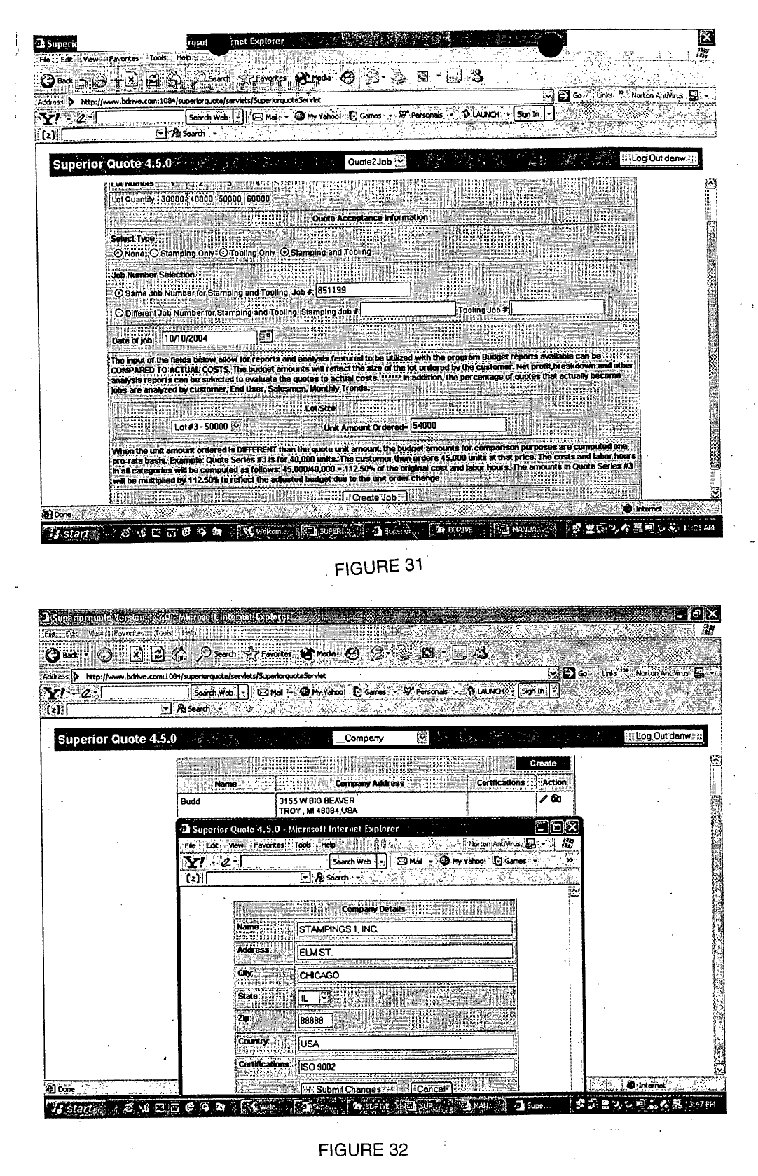

### Other Forms (FIG. 31)

These forms are necessary to complete the quotes. Since the quote system uses drop down fields for the items listed below.
a. Company Information. This refers to the user's company. The software allows for multiple companies in the same organization.
b. Customer Information. This refers to the customers.
c. End User Information. This refers to the ultimate end users of the products.
d. Salesman Information. This refers to the salesmen.
e. Application users. This refers to the users allowed to access the program.

### Reports

There are 3 types of reports. The first set of reports relate to the individual quote items and budget information for jobs. The 2^{nd} set of reports relates to quote and job logs. The 3^{rd} set of reports analyzes the percentage penetration of jobs to quotes for any given date range.

### Analysis—Reports Relating to Specific Quote (FIG. 32)

1. Select Quote. Select the quote to view or print, then click Select Quote button.
2. Item number. Select from drop down the Item to view.
3. Show Report. Click to view report selected in screen.
4. Printable Format. Click inside report being viewed in upper right-hand corner in order to print. Recommended: Check to see if the whole page is showing horizontally on the printed page. If the page is cut off, change the setting to landscape for printing. After the new screen opens, click File, then Page Setup and click landscape. Then click Print for either portrait or landscape setting.

The report offerings are as follows:
1. Summary of quote per 1000 units—stamping. Summarizes costs for up to 10 quantity volumes for each quote item on a per 1000 unit basis.
2. Summary of quote—stamping. Summarizes total costs for up to 10 quantity volumes for each quote item.
3. Net profit, sales, costs per unit and breakeven analysis—stamping.—Analyses of 10 quantity volumes for each item by profit, costs, etc.
4. Labor—hours, costs and breakeven analyses—stamping.—Summarizes labor hours, costs and other analyses.
5. Job budget—stamping.—Provides a budget based upon quote input.
6. Budget—net profit, sales, costs per unit and breakeven analysis—stamping.—Job budget analyses.
7. Budget—Labor—hours, costs and breakeven analyses—stamping.—Labor breakdowns and analyses of job.
8. Shop supervisor budget hours—stamping.—Provides job budget hours only.
9. Summary of quote—tooling. Summarizes costs for tooling.
10. Net profit, sales, costs per unit and breakeven analysis—tooling.—Analyses of profit, costs, etc.
11. Shop supervisor budget hours—tooling. Provides job budget hours only.

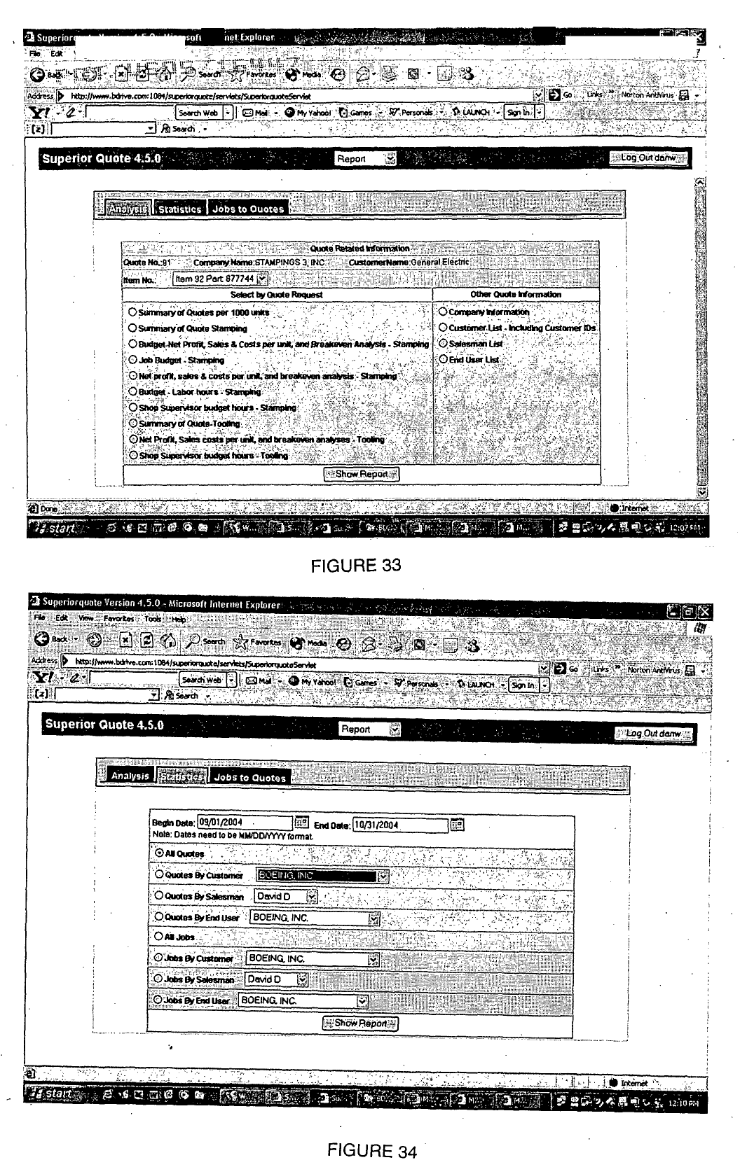

### Statistics—Quote and Job Logs (FIG. 33)

The user can select any date range for all the choices. The report offerings are as follows:
1. All quotes. Lists all quotes sequentially by selected date range.
2. Quotes by customer. Lists all quotes sequentially by selected date range and customer.
3. Quotes by salesman. Lists all quotes sequentially by selected date range and salesman.
4. Quotes by end user. Lists all quotes sequentially by selected date range and end user.
5. All jobs. Lists all jobs sequentially by selected date range.
6. Jobs by customer. Lists all jobs sequentially by selected date range and customer.
7. Jobs by salesman. Lists all jobs sequentially by selected date range and salesman.
8. Jobs by end user. Lists all jobs sequentially by selected date range and end user.

### Jobs to Quotes Percentage Analyses (FIG. 34)

Extensive analysis with charts compares the number of new quotes (number of attempts to obtain new work) to the number of new purchase orders received in a user selected date range. Analysis options include customers, salesmen, end users, and monthly trends. This is pure statistical information without the noise of whether one bid represented more dollars on not. This is a very important management tool, that is very reliable and much more immediate and precise than monthly or quarterly financial statements. Financial statements can actually blur a lot of costs together and it is antecedent to what is showing up in rising purchase orders relative to the amount of quoting. This helps decide, earlier in the business curve, what types of businesses to sell to, what machines to buy, where to sell the services, when to curtail services in certain areas, who should represent the company in sales, etc.

The analysis comparing jobs to quotes, specifically refers to new quote items vs. new quotes. A new quote item is not a requote. The quote item is only counted once. Similarly, this analysis refers to jobs as new jobs. If the company already has the job, there is no further economic benefit in retaining the same job after requoting it for the customer. Consequently, the job is counted only once. Filtering out repeats for quotes and jobs creates a very substantive analysis.

The reports displays the percentage of the number of jobs received (job penetration) to the number of quotes sent to customers. This analysis identifies the areas needing improvement & review. Each analysis can be presented in two ways: 1) by highest percentage of jobs to quotes order, or, 2) by highest absolute number of jobs order.
1. Jobs to quotes percentage analysis—by all customers. Displays charts and schedule for all customers and date range.
2. Jobs to quotes percentage analysis—by specific customer. Displays charts and schedule for selected customer and date range.
3. Jobs to quotes percentage analysis—by top 5 customers. Displays charts and schedule for selected date range of top 5 customers.
4. Jobs to quotes percentage analysis—by bottom 5 customers. Displays charts and schedule for selected date range of bottom 5 customers.
5. Jobs to quotes percentage analysis—by specific salesman. Displays charts and schedule for selected salesman and date range.
6. Jobs to quotes percentage analysis—by top 5 salesmen. Displays charts and schedule for selected date range of top 5 salesmen.
7. Jobs to quotes percentage analysis—by bottom 5 salesmen. Displays charts and schedule for selected date range of top 5 salesmen.
8. Jobs to quotes percentage analysis—by specific end user. Displays charts and schedule for selected end user and date range.
9. Jobs to quotes percentage analysis—by top 5 end users. Displays charts and schedule for selected date range of top 5 end users.
10 Jobs to quotes percentage analysis—by bottom 5 end users. Displays charts and schedule for selected date range of top 5 end users.

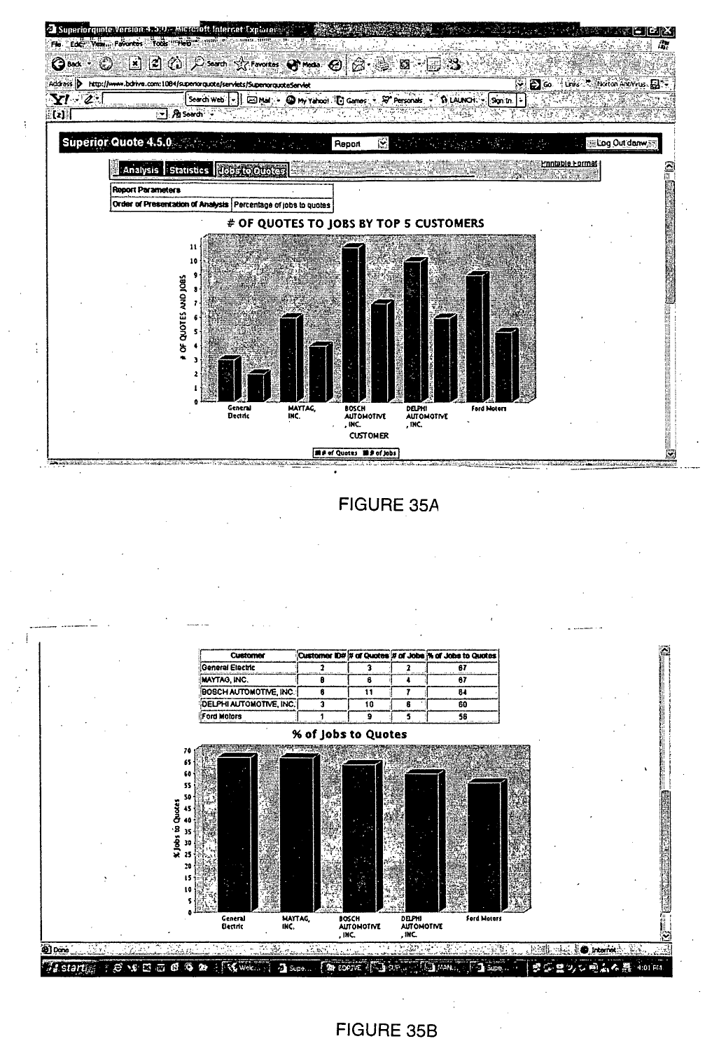

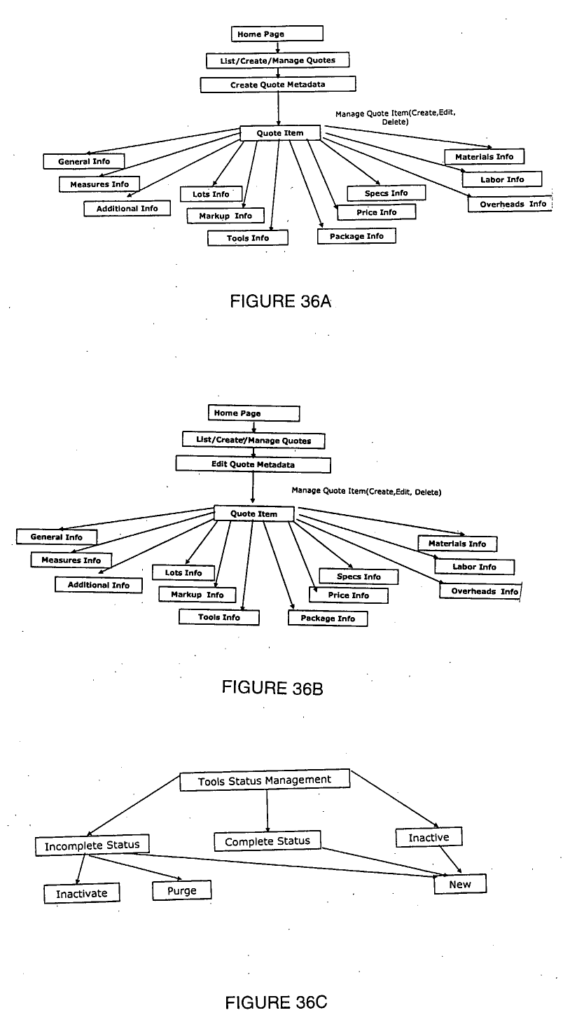

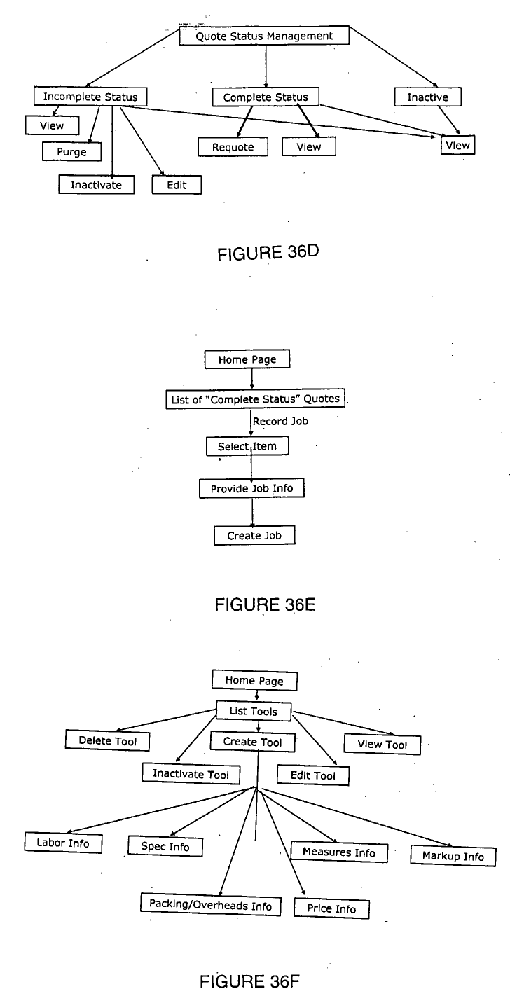

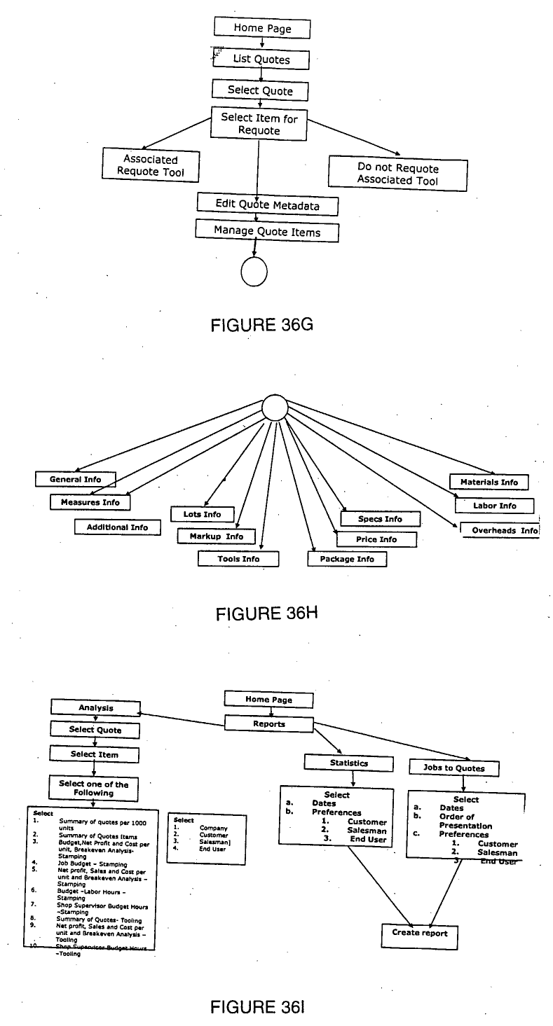

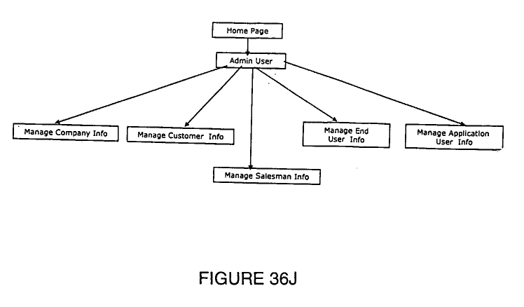

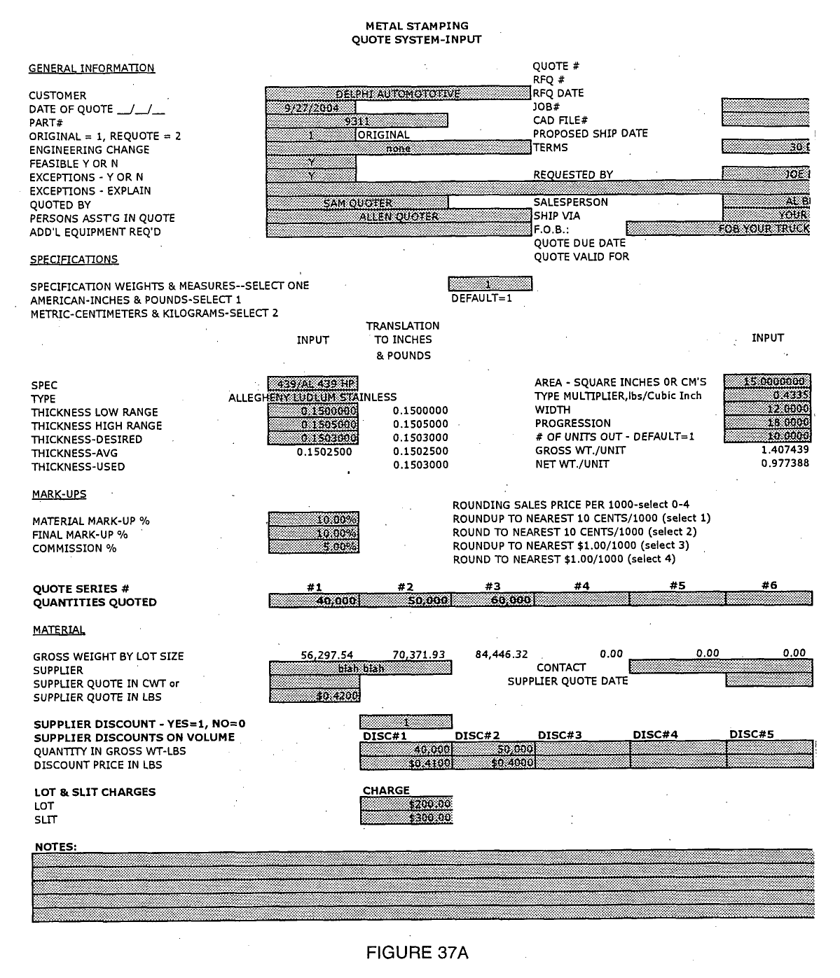

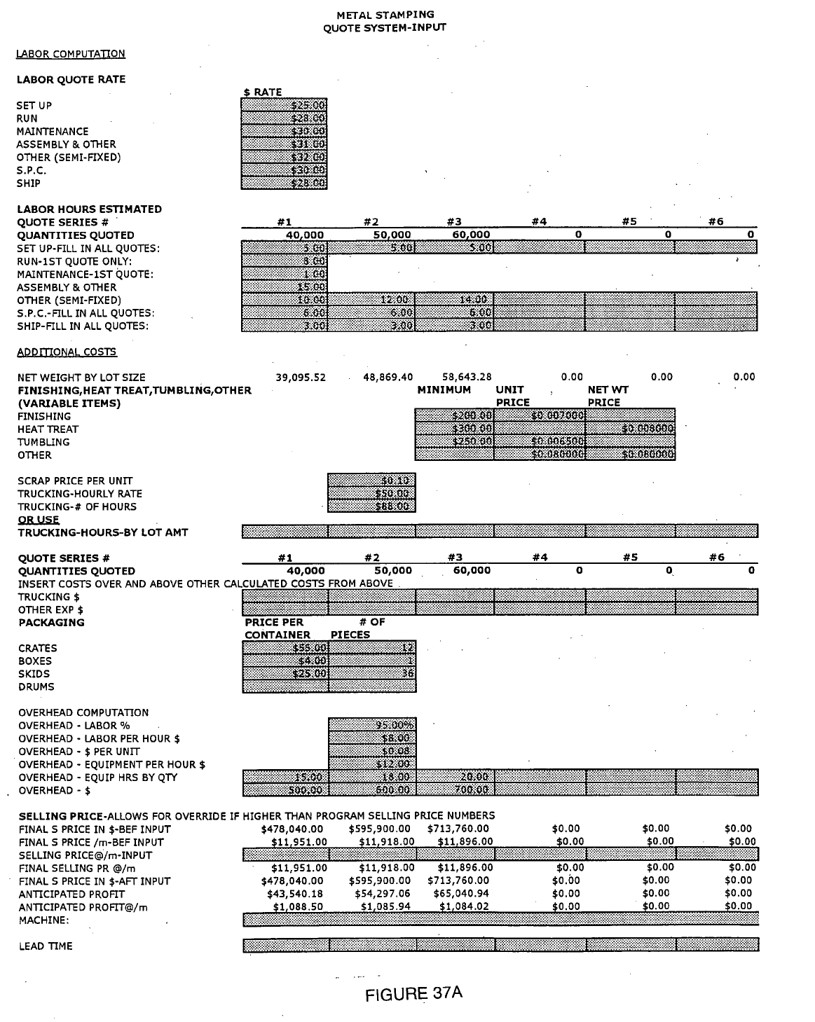

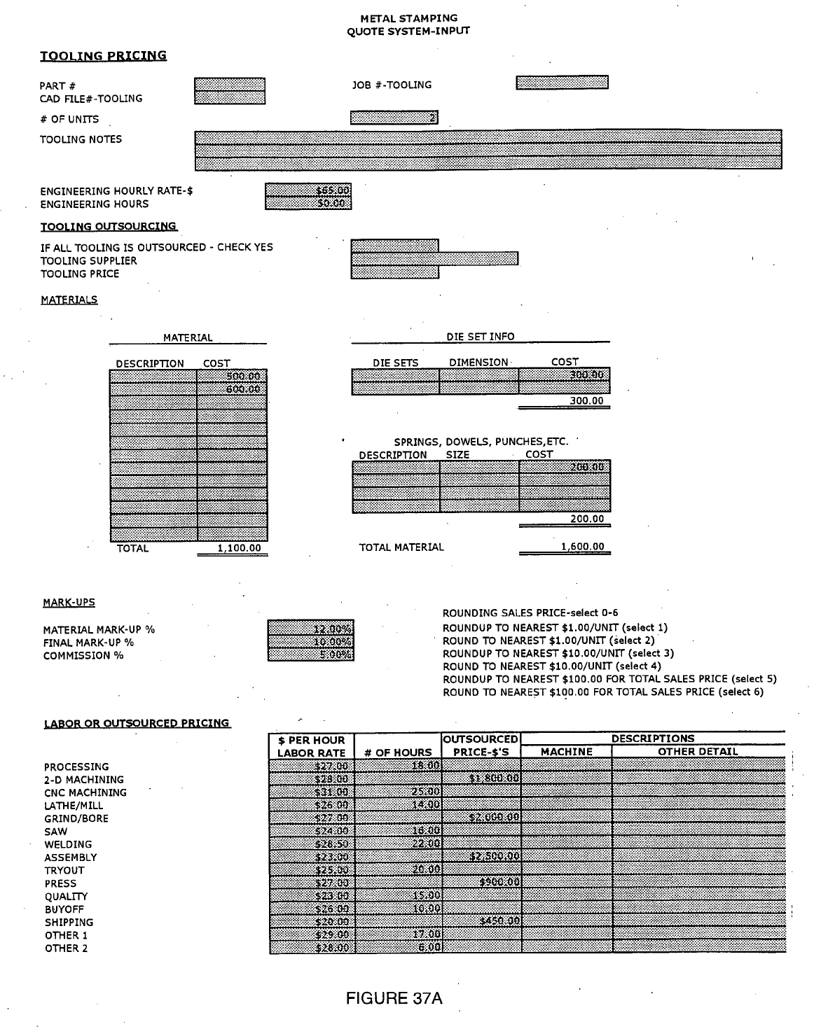

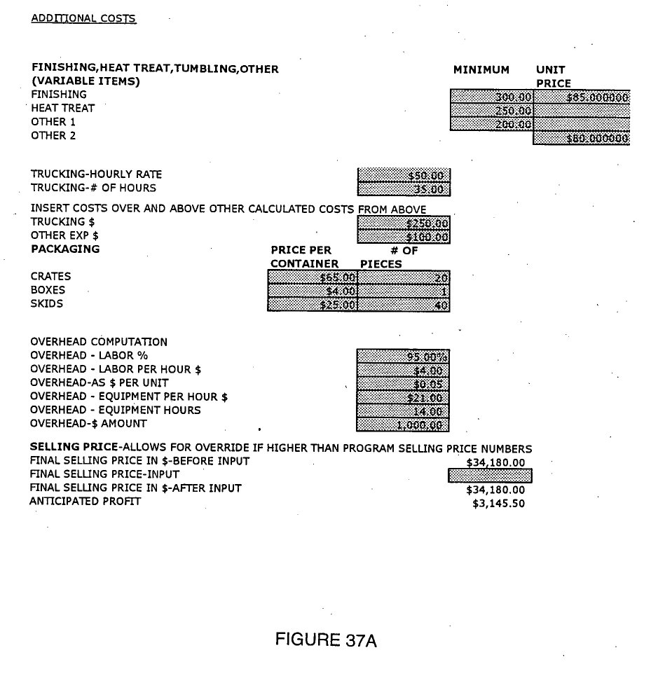

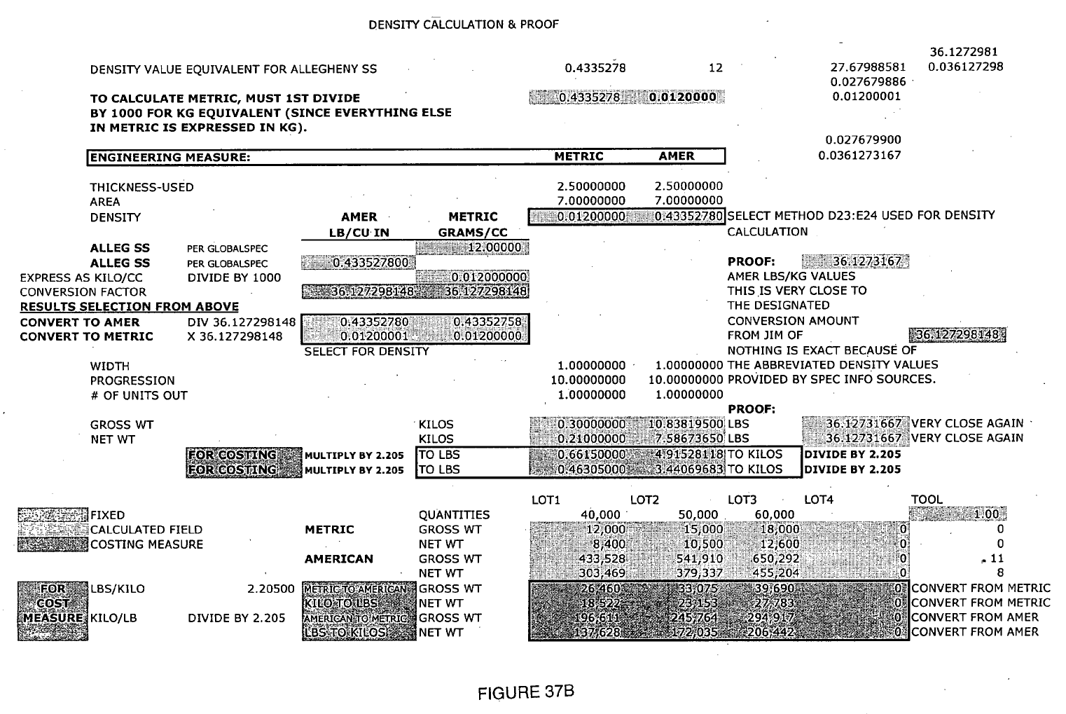

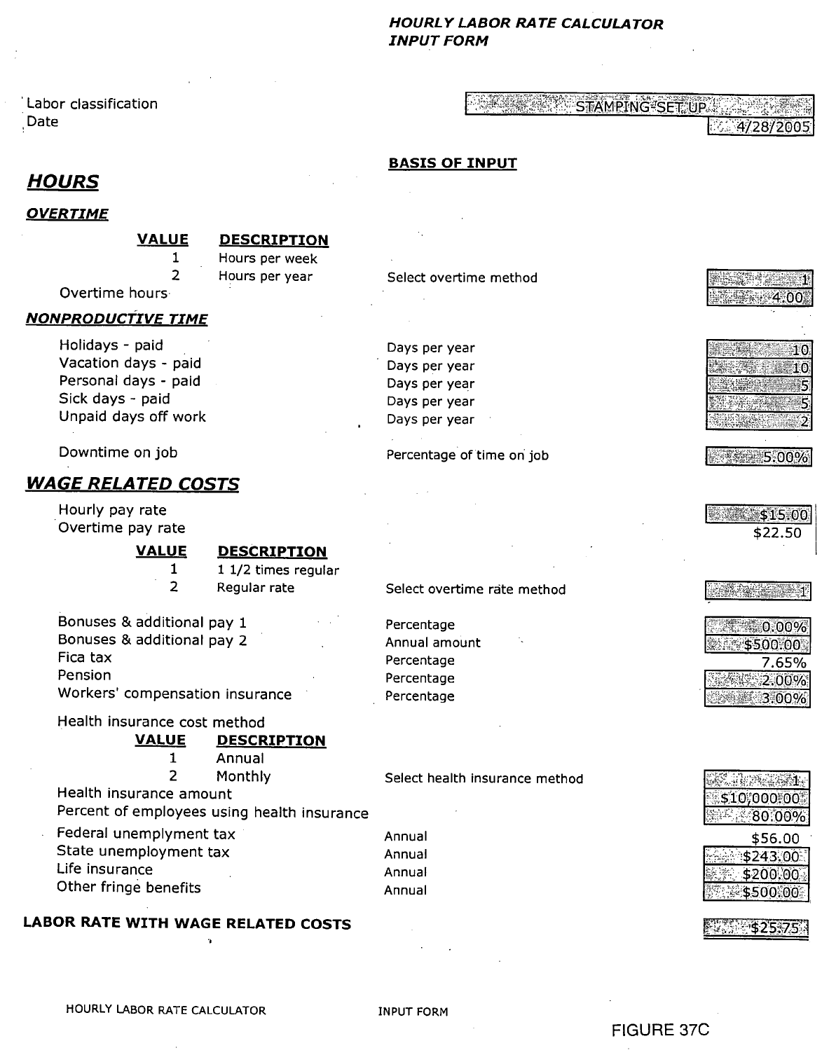

A sample report of top 5 customers comparing the number of new jobs to new quotes by percentage order for any date range is shown in FIGS. 35A and 35B.

### System Requirements

This software application is web-based. Upon satisfying the Application Server requirement, access to the software is very simple. Any user can connect to the software through use of a user id number and password.

### Infrastructure Needs

Infrastructure needs to host the application requires an Application Server such as Sun Microsystems's iPlanet or BEA's Weblogic server or via a server maintained by applicant, which provides a URL to access the account.

### Individual User Needs

There is no limitation to the number of users allowed to enter and receive contemporaneous information. Individual user needs include:
1. A computer with an internet connection and an internet browser.
2. Assignment of a user id number.
3. Assignment of a password.
4. Designation of view status level. The Admin level can view everything. The User level can only view their quote work. The status level is selected from the Application User section.
5. If the user cannot see the entire page horizontally, it is recommended to switch the monitor display to 1024×768. Go to Control Panel, then Display, then Settings. Then select 1024×768, and click yes.

Throughout this application, author and year, and patents, by number, reference various publications, including United States patents. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention can be practiced otherwise than as specifically described.

What is claimed is:

1. A method for automatically generating a price quote by inputting information relevant to the price quote into software and automatically generating the quote using the software.

2. The method according to claim 1, further including analyzing current and past quotes for accuracy.

3. The method according to claim 2, wherein said analyzing step includes creating charts depicting quoted costs, markups, anticipated profit, labor hours, sales price per labor hour, and breakeven hours over the quote estimate.

4. The method according to claim 1, further including accessing the software via security devices.

5. The method according to claim 4, wherein said accessing step includes providing a user id and a password to a secure server.

6. The method according to claim 1, further including linking the software to existing accounting software.

7. Automatic quoting means for automatically generating quotes.

8. The automatic quoting means according to claim 7, wherein said means is software.

9. The automatic quoting means according to claim 7, wherein said software includes the source code provided in FIG. 4.

10. The automatic quoting means according to claim 7, wherein said software is written in a language selected from the group consisting of C+, C++, C+++, SQL, Microsoft Excel, Java, and HTML.

11. The automatic quoting means according to claim 7, wherein said quoting means includes pricing means for estimating pricing.

12. The automatic quoting means according to claim 11, wherein said pricing means calculate prices based on a number selected from the group consisting essentially of per unit basis, a per thousand or hundred basis, based on dollar totals, based on thousand dollar totals, based on percentages, based on material specifications and cost input, net weight, flat dollar costs, and materials costs.

13. The automatic quoting means according to claim 7, wherein said quoting means includes materials calculating means for estimating materials costs.

14. The automatic quoting means according to claim 13, wherein said materials calculating means calculate based on a number selected from the group consisting essentially of gross weight, net weight per unit from specification input and low and high tolerances of the required material

15. The automatic quoting means according to claim 7, wherein said quoting means includes packaging quoting means for estimating packaging costs.

16. The automatic quoting means according to claim 15, wherein said packaging means automatically calculates the correct amount of containers for pricing based on input.

17. The automatic quoting means according to claim 7, wherein said quoting means includes overhead quoting means for estimating overhead costs.

18. The automatic quoting means according to claim 17, wherein said overhead means calculates overhead by means selected from the group consisting essentially of labor dollar in percentage terms, labor hourly rate, and equipment hourly rate by unit.

19. The automatic quoting means according to claim 7, wherein said quoting means includes selling price means for estimating selling prices.

20. The automatic quoting means according to claim 19, wherein said selling price means enables a user to override the price generated by the program.

21. The automatic quoting means according to claim 7, further including security means for providing secure access to said quoting means.
